(19) United States
(12) Patent Application Publication
(10) Pub. No.: US 2019/0207966 A1
(43) Pub. Date: Jul. 4, 2019

(54) Platform and Method for Enhanced Cyber-Attack Detection and Response Employing a Global Data Store

(71) Applicant: FireEye, Inc., Milpitas, CA (US)

(72) Inventors: Sai Vashisht, Morgan Hill, CA (US); Alexander Otvagin, Campbell, CA (US)

(21) Appl. No.: 16/222,194

(22) Filed: Dec. 17, 2018

Related U.S. Application Data
(60) Provisional application No. 62/611,487, filed on Dec. 28, 2017.

(51) Int. Cl. H04L 29/06; G06F 16/28

(52) U.S. Cl. CPC H04L 63/1425; G06F 16/285; H04L 63/1416

(57) ABSTRACT

A system for detecting artifacts associated with a cyber-attack features a cybersecurity intelligence hub that includes a data store with stored meta-information associated with each artifact of a plurality of artifacts and each stored meta-information includes a verdict classifying an artifact corresponding to the stored meta-information as a malicious classification or a benign classification. The hub is configured to (i) receive meta-information associated with a first artifact from a cybersecurity sensor, and (ii) determine a verdict for the first artifact based on an analysis of meta-information associated with the first artifact stored meta-information associated with each of the plurality of artifacts. A verdict for the first artifact is returned to the cybersecurity sensor in response to a detected match between a portion of stored meta-information and a portion of the meta-information associated with the first artifact.

### CROSS-REFERENCE TO RELATED APPLICATIONS

This application claims the benefit of priority on U.S. Provisional Application No. 62/611,487 filed Dec. 28, 2017 (Attorney Docket No. 101966.0148PRO), the entire contents of which are incorporated by reference herein.

### FIELD

Embodiments of the disclosure relate to the field of cybersecurity. More specifically, one embodiment of the disclosure relates to a comprehensive cybersecurity platform including a cybersecurity intelligence hub that controls storage, retrieval and distribution of cybersecurity intelligence.

### GENERAL BACKGROUND

Cybersecurity attacks have become a pervasive problem for organizations as many networked devices and other resources have been subjected to attack and compromised. A cyber-attack constitutes a threat to security arising out of stored or in-transit data which, for example, may involve the infiltration of any type of content, such as software for example, onto a network device with the intent to perpetrate malicious or criminal activity or even a nation-state attack (e.g., “malware”).

Recently, malware detection has undertaken many approaches involving network-based, malware protection services. One conventional approach involves placement of malware detection devices at the periphery of and throughout an enterprise network. This approach is adapted to (i) analyze information propagating over the network to determine a level of suspiciousness and (ii) conduct a further analysis of the suspicious information by a separate malware detection system or internally within the malware detection device itself. While successful in detecting known malware that is attempting to infect network devices connected to the network (or subnetwork), as network traffic increases, the malware detection devices may exhibit a decrease in performance, especially in detecting advanced (or unknown) malware due to their limited accessibility to cybersecurity intelligence.

Currently, no concentrated efforts have been made to leverage the vast amount of available cybersecurity intelligence in efforts to provide more rapid malicious object (or event) detection, increased accuracy in cyber-attack detection, and increased visibility and predictability of cyber-attacks, their proliferation, and the extent of their infection.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 is an exemplary block diagram of an exemplary embodiment of a comprehensive cybersecurity system.

FIG. 2A is an exemplary embodiment of the cybersecurity intelligence hub of FIG. 1 communicatively coupled to sources and consumers of cybersecurity intelligence.

FIG. 2B is a first exemplary embodiment of the cybersecurity intelligence hub of FIG. 1.

FIG. 2C is a second exemplary embodiment of the cybersecurity intelligence hub of FIG. 1.

FIG. 3A is a first exemplary embodiment of the logical architecture of the cybersecurity sensor deployed within the comprehensive cybersecurity system of FIG. 1

FIG. 3B is a second exemplary embodiment of the cybersecurity sensor collectively operating with an auxiliary network device deployed within or outside of the comprehensive cybersecurity system of FIG. 1.

FIG. 3C is an exemplary embodiment of the logical architecture of an agent deployed within the comprehensive cybersecurity system of FIG. 1.

FIG. 4 is an exemplary block diagram of an exemplary embodiment of logic implemented within the cybersecurity intelligence hub of FIGS. 2A-2C.

FIG. 5 is an exemplary block diagram of logic implemented within the cybersecurity intelligence hub of FIGS. 2A-2C and the signaling exchange via network interface(s).

FIG. 6 is an exemplary flow diagram of operations conducted by different sets of plug-ins illustrated in FIGS. 2B-2C.

FIG. 7 is an exemplary flow diagram of operations conducted by a plug-in of a first set of plug-ins deployed within the cybersecurity intelligence hub of FIG. 2A for responding to low-latency requests for analytics associated with a selected object.

FIG. 8 is an exemplary flow diagram of operations conducted by a plug-in of a second set of plug-ins deployed within the cybersecurity intelligence hub of FIG. 2A for responding to requests for analytics.

FIG. 9 is an exemplary flow diagram of operations conducted by a plug-in of a third set of plug-ins deployed within the cybersecurity intelligence hub of FIG. 2A in analyzing stored cybersecurity intelligence and generating additional cybersecurity intelligence based on the analyzed, stored cybersecurity intelligence.

### DETAILED DESCRIPTION

Embodiments of the present disclosure generally relate to a comprehensive cybersecurity platform and method that, depending on the embodiment, parses, formats, stores, manages, updates, analyzes, retrieves, and/or distributes cybersecurity intelligence maintained within a global data store to enhance cyber-attack detection and response. The “cybersecurity intelligence” includes meta-information associated with an “artifact” (i.e., an object, an event, indicator of compromise, or other information that may be subjected to cybersecurity analyses), which may be received from a plurality of different network devices operating as cybersecurity intelligence sources. Each artifact may have been determined to be of a known classification (e.g., benign or malicious) or an unknown classification (e.g., not previously analyzed or analyzed with inconclusive results). This classification of an artifact is referred to as the “verdict”.

Responsive to a request from a network device operating as a cybersecurity intelligence consumer, a portion of meta-information pertaining to a prior evaluated artifact corresponding to the monitored artifact (e.g., verdict) may be provided to the requesting cybersecurity intelligence consumer, thereby reducing analysis time and increasing analysis accuracy by that consumer. Furthermore, or in the alternative, portions of the meta-information may be used to generate additional meta-information that assists a cyber-attack analyst, cyber-attack incident investigator, or a security administrator (generally referred to as a “authorized agent”) to better understand the nature, intent, scope and/or severity of a particular cyber-attack and/or malware associated with the cyber-attack, or even to verify whether a cyber-attack has occurred.

### I. Detailed Overview

Embodiments of the present disclosure generally relate to a comprehensive cybersecurity platform featuring multiple (two or more) stages propagating cybersecurity intelligence between a cybersecurity intelligence hub located as a public or private cloud-based service and other cybersecurity sources and consumers. One example of the comprehensive cybersecurity platform includes a cybersecurity intelligence hub (first stage) that provides access to prior analysis results and verifies artifact classifications by one or more cybersecurity sensors. The cybersecurity intelligence hub is configured to monitor artifacts on a global scale, while reducing the overall network throughput requirements and mitigating repetitive analytics on identical artifacts. This allows for better platform scalability without adversely affecting the currency or relevancy of stored metadata within the cybersecurity intelligence hub.

More specifically, for this embodiment of the disclosure, as part of the comprehensive cybersecurity platform, the cybersecurity intelligence hub is communicatively coupled to a plurality of network devices. Each of the network devices corresponds to a cybersecurity intelligence source (“source”) or a cybersecurity intelligence consumer (“consumer”), where certain network devices, such as a cybersecurity sensor for example, may be categorized as both a source and a consumer. Hence, the cybersecurity intelligence hub may operate as (i) a central facility connected via a network to receive meta-information from the sources; (ii) an intelligence analytics resource to analyze the received meta-information, including results from an analysis of meta-information or artifacts received from disparate sources, and store the analysis results with (or cross-referenced with) the received meta-information; and/or (iii) a central facility serving as a distribution hub connected via a network to distribute the stored meta-information to the consumers. In a centralized deployment, the cybersecurity intelligence hub may be deployed as a dedicated system or as part of cloud-based malware detection service (e.g., as part of, or complementary to and interacting with the cybersecurity detection system and service described in detail in U.S. patent application Ser. No. 15/283,126 entitled “System and Method For Managing Formation and Modification of a Cluster Within a Malware Detection System,” filed Sep. 30, 2016; U.S. patent application Ser. No. 15/721,630 entitled “Multi-Level Control For Enhanced Resource and Object Evaluation Management of Malware Detection System,” filed Sep. 29, 2017; and U.S. patent application Ser. No. 15/857,467 entitled “Method and System for Efficient Cybersecurity Analysis of Endpoint Events,” filed Dec. 28, 2017, the entire contents of all of these applications are incorporated by reference herein).

As described below, the cybersecurity intelligence hub includes a global data store communicatively coupled to a data management and analytics engine (DMAE) and a management subsystem. The global data store operates as a database or repository to receive and store cybersecurity intelligence, which consolidates meta-information associated with a plurality of artifacts for storage therein. Each artifact of the plurality of artifacts has been (i) previously analyzed for malware and determined to be of a malicious or benign classification, (ii) previously analyzed for malware without conclusive results and determined to be of an “unknown” verdict, or (iii) previously not analyzed (or awaiting analysis), and thus of an “unknown” verdict. In general terms, the global data store contains the entire stockpile of cybersecurity intelligence collected and used by individuals, businesses, and/or government agencies (collectively, “customers”), which is continuously updated (through a process akin to “crowd sourcing”) by the various intelligence sources and by the DMAE to maintain its currency and relevancy. The global data store may be implemented across customers of a particular product and/or service vendor or across customers of many such vendors.

Herein, the stored cybersecurity intelligence within the global data store includes meta-information associated with analyzed or unanalyzed artifacts, which are gathered from a variety of disparate cybersecurity sources. One cybersecurity source includes cybersecurity sensors located at a periphery of a network (or subnetwork) and perhaps throughout the network. A “cybersecurity sensor” corresponds to a physical network device or a virtual network device (software) that assists in the detection of cyber-attacks or attempted cyber-attacks and provides alert messages in response to such detection. A cybersecurity sensor may feature malware detection capabilities such as, for example, static malware analysis (e.g., anti-virus or anti-spam scanning, pattern matching, heuristics, and exploit or vulnerability signature matching), run-time behavioral malware analysis, and/or event-based inspection using machine-learning models. Another cybersecurity source provides, via a network device, cybersecurity intelligence utilized by highly trained experts such as cybersecurity analysts, forensic analysts, or cyber-incident response investigators. Also, another cybersecurity source provides cybersecurity intelligence from a cybersecurity vendor, academic, industry or governmental report.

In general, the cybersecurity intelligence hub maintains meta-information associated with actual or potential cyber-attacks, and more specifically with artifacts constituting actual or potential malware that are encountered (and, depending on the embodiment, already analyzed or not) by the cybersecurity intelligence sources. Additionally, the meta-information may include information associated with artifacts classified as benign, in lieu of only malicious artifacts, in order to provide a more comprehensive view of the cybersecurity threat landscape experienced by customers of the comprehensive cybersecurity platform described below. The cybersecurity intelligence may be consumed by many of these same sources and possibly other network devices, e.g., subscribing customers, including governmental, regulatory or enforcement based agencies that provide no cybersecurity intelligence sourcing. These sources and consumers constitute a cybersecurity community built around the cybersecurity intelligence hub.

As described in detail below, the global data store is an intrinsic part of the operation and effectiveness of the cybersecurity intelligence hub. For instance, according to one embodiment of the disclosure, a customer-deployed, cybersecurity sensor (e.g., a malware detection appliance being a general purpose computer performing cybersecurity analyses or a dedicated cybersecurity device, a software agent or other security software executing on a network device, etc.) receives meta-information (and possibly the artifact) for verdict verification. Based on the meta-information, the sensor determines whether the artifact has been previously analyzed and a verdict for that artifact is available. This determination may be performed by either (i) extracting “distinctive” metadata from the meta-information that differentiates the artifact (e.g., events, objects, etc.) from other artifacts or (ii) generating the distinctive metadata from the artifact itself. For some artifacts (e.g., objects), the distinctive metadata may include an identifier (e.g., object ID). The object ID may be a hash of the object (e.g., hash value), a checksum, or other representation based on content forming the object or information identifying the object such as a filename, or a Uniform Resource Locator (URL). For other artifacts (e.g., network connection events), a grouping of Internet Protocol (IP) addresses and/or ports may operate as the distinctive metadata.

Thereafter, the logic within the sensor accesses meta-information within a data store (on-board the sensor or accessible and preferably local to the sensor) and compares this meta-information to the distinctive metadata (e.g., object ID for an object being the artifact). Based on the results of this comparison, if a match is detected, the logic within the sensor concludes that the artifact has been previously provided to the cybersecurity intelligence hub. Hence, in some embodiments, the sensor refrains from uploading the meta-information to the cybersecurity intelligence hub. However, if a match is not detected, the logic within the sensor considers the artifact has not been previously analyzed, stores the meta-information, and provides the meta-information to the cybersecurity intelligence hub. The cybersecurity intelligence hub receives the meta-information from the sensor, including the distinctive metadata (e.g., object ID), and determines whether the global data store includes one or more entries for that artifact in order to return a “consolidated” verdict to the sensor.

As an example, when the artifact is an object or a process behavior or other event related to an identified object (described below), the distinctive metadata includes a hash value of the object (object ID), which may operate as a search index for stored meta-information within the global data store. The logic within the DMAE of the cybersecurity intelligence hub attempts to determine whether the object ID matches (e.g., is identical or has a prescribed level of correlation with) a stored object ID. For this example, a “match” is determined when the object ID is found to be part of stored meta-information associated with a previously analyzed object (generally referred to as “prior evaluated” artifact). Given the cybersecurity intelligence hub supports multiple sensors, it is contemplated that meta-information for the same detected artifact (e.g., object) from different sensors may reside within the global data store (referred to as the “consolidated meta-information” associated with the object). The verdicts (e.g., malicious, benign, unknown) associated with the stored, consolidated meta-information for the object may be returned from the global store to the analytics logic. Depending on the rules for generating the consolidated verdict that control its operability, the analytics logic may determine the consolidated verdict for the artifact as a known (malicious, benign) classification or an unknown classification. In fact, in some embodiments, the consolidated verdict may remain at an “unknown” status until a predetermined number of analyses of the artifact (e.g., the number of analyses exceeding a verdict count threshold, as described below) share the same verdict.

The cybersecurity sensor may be configured to operate pursuant to a variety of different workflows based on the received consolidated verdict. In response to receiving a “malicious” consolidated verdict for an artifact (based upon consolidated meta-information associated with a prior evaluated artifact), the cybersecurity sensor may issue or initiate an alert message (alert) to a security administrator, which includes information that enables an action to be undertaken by the security administrator and/or causes further analysis of the artifact to be initiated. This further analysis may include acquiring additional meta-information regarding the artifact including its characteristics and/or behaviors and its present context (e.g., state information, software profile, timestamp, etc.) to be subsequently uploaded into the global data store. Herein, an “alert” may be a system-initiated notification on a particular cybersecurity matter (sent, for example, via email or text message) while a “report” may be an alert or a system-initiated or recipient-initiated download that can provide greater detail than an alert on a cybersecurity matter.

For a “benign” consolidated verdict, the cybersecurity sensor may terminate further analysis for the artifact. For an “unknown” consolidated verdict, the cybersecurity sensor may initiate further analyses as described below, where the unknown verdict is due to a lack of either (i) an entry in the global data store matching to the artifact or (ii) an entry indicating the artifact has been analyzed previously but with inconclusive results (e.g., not having satisfied benign or maliciousness thresholds, or (iii) the verdict count threshold corresponding to a prescribed number of verdicts needed from different analyses has not been exceeded).

The cybersecurity intelligence hub can also be queried at any point of time by the sensor (or by a customer via a portal) to check for additional or updated meta-information. The meta-information may involve a verdict of a prior evaluated artifact, updated information based on newly obtained meta-information from recent analysis results, information to assist in remediation of malware, and/or information regarding the current cybersecurity threat landscape.

It is contemplated that, where the artifact is a URL for example, the cybersecurity intelligence hub may contain meta-information stored within the global data store identifying the server associated with the URL, including whether that server is considered, by one or more prior verdicts associated with other communications, to have a high probability of being a malicious server. In response, based on this server-based meta-information, the cybersecurity intelligence hub may associate a high weighting or score with the artifact in classifying the artifact as malicious.

The cybersecurity sensor may also communicate results of its initiated analysis to the global data store, where the analysis results are added to an entry (or entries) associated with the artifact being analyzed and becoming part of the consolidated meta-information for that artifact. It is anticipated that the sources will be regularly updating the global data store with new results, thus maintaining the currency and relevancy of its recorded cybersecurity information as further information concerning previously identified cyber-attacks is uncovered, new cyber-attacks are identified, and, generally, additional artifacts are encountered and possibly analyzed and determined to be of benign, malicious or unknown classification. Of considerable benefit, contextual information included as part of the stored meta-information from prior verdicts can be used to assess the nature, vector, severity, and scope of a potential cyber-attack. Since the global data store maintains and provides analysis results from potentially disparate sources (sometimes cross-customer, cross-industry, or cross-vector), the cybersecurity intelligence maintained within the global data store can be used to generate a comprehensive view of a cyber-attack, even for attacks involving sophisticated (e.g., multi-vector or multi-phased) malware and cyber-attack campaigns that may be missed by “single point” malware detection systems.

In accordance with one embodiment of the disclosure, the DMAE of the cybersecurity intelligence hub further includes analytics logic and data management logic. The data management logic may be configured to manage organization such as normalizing data into a selected data structure or format, updating index mapping tables, and/or removing certain data (e.g., parameters such as personal identification information, entered passwords, etc.) that is not required for cybersecurity analysis. Additionally, the data management logic may be configured to perform retrieval (read) and storage (write) of the cybersecurity intelligence within the global data store. The analytics logic may be configured to receive request messages for information from any cybersecurity sensor or other consumers of the cybersecurity intelligence, including security analysts or administrators for example. One type of request message is a request for cybersecurity intelligence (e.g., verdict) pertaining to an artifact while another type of request message is a query for stored analysis results for a particular customer.

According to one embodiment of the disclosure with a modular architecture, the analytics logic is communicatively coupled to a plurality of software modules (e.g., plug-ins) installed within the DMAE to handle request messages and perform specialized analytics. Herein, for this embodiment, the analytics logic parses the request message to extract at least a portion of the meta-information (e.g., distinctive metadata), invokes (selects and/or activates) one or more plug-ins, provides the extracted portion of the meta-information to the one or more selected plug-ins, receives analysis results from the one or more plug-ins, and, in some cases, processes those results to determine the consolidated verdict in accordance with rules for generating the consolidated verdict that control its operability (referred to as “consolidated verdict determination rules”).

The consolidated verdict determination rules may be static or configurable via download or a user portal. According to one embodiment of the disclosure, the analytics logic is configured to invoke and activate one or more plug-ins for processing, where the plugins may be activated concurrently (in a time-overlapping fashion) or sequentially, and the determination of which one or more plug-ins to activate and their order in which they are activated may be determined prior to invoking any of the one or more plug-ins or may be determined dynamically later during or after analysis by one or more plug-ins. For example, the analytics logic may be configured to activate one or more plug-ins for processing of a request message (request or query) in accordance with a prescribed order, based on a request type and/or meta-information results of a prior analysis by a plug-in. More specifically, one selection process may involve the analytics logic selecting an available plug-in, and after completion of such operations, invoking another plug-in to render a consolidated verdict. In some embodiments, the selection of a “next” plug-in may be in accordance with analysis ordering rules, or conditional rules (e.g., an “if this, then that” rule as applied to the type of object or a prior analysis result), which may be user configurable and/or stored with the consolidated verdict determination rules.

According to another embodiment of the disclosure, the analytics logic may be configured to also analyze the received, consolidated meta-information in accordance with the consolidated verdict determination rules. Some of these rules may be coded to preclude the return of a requested verdict unless a prescribed number of analysis results conclude the same, consistent verdict from the same source or from different sources.

As described herein, the plurality of plug-ins may include different sets (one or more) of plug-ins that handle different categories of request messages. For instance, a first set of plug-ins may handle low-latency (real-time) request messages requiring a response message to be returned promptly (e.g., within a prescribed duration after receipt of the request message and/or during the same communication session). A second set of plug-ins may handle queries for stored consolidated meta-information for a particular network device or customer, which allow for greater latency (e.g., minutes) in handling and, for at least some of these plug-ins, the consolidated meta-information may be returned during a different (subsequent) communication session. A third set of plug-ins may handle the generation of additional cybersecurity intelligence and are invoked in response to a triggering event, namely a dynamic event (e.g., analysis results received from another plug-in for continued analysis) or a scheduled event (e.g., whereupon a plug-in operates as a foreground or background process on a periodic or aperiodic schedule). For example, the scheduled activation may occur as a timeout condition when a prescribed period of time has elapsed since the last activation of a plug-in, a max count condition where a prescribed number of monitored events have occurred such as a prescribed number of request messages have been made, a number of entry accesses have been performed, etc. since the last activation of a plug-in.

Hence, the plurality of plug-ins may include some or all of the following: (1) plug-in(s) to generate responses to request messages, sent by the cybersecurity sensors and other consumers where artifacts are found benign or malicious consistently in other prior analysis verdicts; (2) plug-in(s) to generate models and training of such models to handle low-latency request messages; (3) plug-in(s) to generate responses to signal a user of an “unknown” verdict and include information for certain operations to assist in the analysis and classification of the artifact; (4) plug-in(s) to identify inconsistent verdicts, prompt determination to confirm accuracy of (verify) prior analyses results and notify an administrator (or customer) of incorrect verdicts previously provided and changes in such verdicts; and/or (5) plug-in(s) to identify short or long term trends or targeted and deliberate cyber-attack campaigns by analysis of the cybersecurity threat landscape.

According to another embodiment of the cybersecurity intelligence hub, the data management logic is communicatively coupled to the second set of plug-ins and invokes one or more plug-ins of the second set of plug-ins to handle other request messages directed to higher-latency (generally non-real time) analyses upon receipt of the request message (or meta-information associated with the request message) by the analytics logic for processing. Herein, the data management logic is configured to select the particular plug-in(s) to handle a request for and return of results from the request message where timeliness of the response is of less importance. The results may be temporarily stored and provided to the requesting cybersecurity sensor. The data management logic still manages the organization, retrieval and storage of the cybersecurity intelligence within the global data store.

In summary, as an illustrative embodiment, the cybersecurity intelligence hub may receive a request message over a network from a cybersecurity sensor. Responsive to the request message being directed to a low-latency analysis (e.g., requesting a prior verdict associated with a particular artifact encountered by the sensor), the analytics logic invokes one or more plug-ins (referred to as “plug-in(s)”) from the first set of plug-ins. The selected plug-in(s) signal the data management logic to check the global data store for one or more entries including stored meta-information pertaining to a prior evaluated artifact that matches particular distinctive metadata associated with the particular artifact (e.g., comparison of object IDs such as hash values, checksums or any collection of data to specifically identify the object, etc.). Upon locating at least one entry, the data management logic retrieves the consolidated meta-information from that entry or entries (e.g., verdicts and other meta-information such as software profile operating during runtime when the artifact was detected or timestamp associated with the detection of the artifact) and provides the retrieved consolidated meta-information to the analytics logic. Thereafter, according to one embodiment of the disclosure, the analytics logic returns at least the consolidated verdict (and perhaps other portions of the consolidated meta-information) to the requesting sensor. All the while, the analytics logic tracks the request message (message ID) and the requesting sensor (sensor ID) and causes the communication session established through a network interface of the cybersecurity intelligence hub to remain open in servicing this low-latency request.

According to another embodiment of the disclosure, operating with the DMAE, the management subsystem of the cybersecurity intelligence hub may be communicatively coupled to the third set of plug-ins, which are configured to generate additional cybersecurity intelligence based on analyses of stored cybersecurity intelligence within the global data store. Herein, the third set of plug-ins may be invoked by the analytics logic in response to a triggering event, as described above. In response to a triggering event, the management subsystem may also invoke one or more plug-ins of the third set of plug-ins to analyze a portion of the stored cybersecurity intelligence and generate additional cybersecurity intelligence to provide more context information in assessing future cyber-attacks. For example, a retroactive re-classification plug-in may be installed as one of these plug-ins to monitor, confirm and perform system-wide correction of prior false positive (FP) and/or false negative (FN) results, as described below.

It is contemplated that other inventive aspect, directed to the sharing and exchange of meta-information directed to malicious and benign artifacts may result in the formulation of heuristic rules and/or signatures as well as future guidance as to incident investigations and heightened threat protections is described below.

### II. Terminology

In the following description, certain terminology is used to describe aspects of the invention. In certain situations, each of the terms “logic,” “system,” “component,” or “engine” is representative of hardware, firmware, and/or software that is configured to perform one or more functions. As hardware, the logic (or system/component/engine) may include circuitry having data processing or storage functionality. Examples of such circuitry may include, but are not limited or restricted to a microprocessor, one or more processor cores, a programmable gate array, a microcontroller, an application specific integrated circuit, wireless receiver, transmitter and/or transceiver circuitry, semiconductor memory, or combinatorial logic.

Alternatively, or in combination with the hardware circuitry described above, the logic (or system/component/engine) may be software in the form of one or more software modules. The software modules may include an executable application, a daemon application, an application programming interface (API), a subroutine, a function, a procedure, an applet, a servlet, a routine, source code, a shared library/dynamic load library, or one or more instructions. The software module(s) may be stored in any type of a suitable non-transitory storage medium, or transitory storage medium (e.g., electrical, optical, acoustical or other form of propagated signals such as carrier waves, infrared signals, or digital signals). Examples of non-transitory storage medium may include, but are not limited or restricted to a programmable circuit; a semiconductor memory; non-persistent storage such as volatile memory (e.g., any type of random access memory “RAM”); persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the executable code may be stored in persistent storage.

A “network device” generally refers to either a physical electronic device featuring data processing and/or network connection functionality or a virtual electronic device being software that virtualizes at least a portion of functionality of the physical network device. Examples of a network device may include, but are not limited or restricted to, a server, a mobile phone, a computer, a set-top box, a standalone malware detection appliance, a network adapter, or an intermediary communication device (e.g., router, firewall, etc.), a virtual machine, or any other virtualized resource.

The term “consolidated verdict” generally refers to a selected verdict for an artifact that normally coincides with at least one verdict of a plurality of verdicts pertaining to the artifact that may have been received from multiple sources. One exception may be when the consolidated verdict is set to an “unknown” classification.

The term “meta-information” generally refers to a collection of information associated with an artifact. One type of meta-information is referred to as “consolidated meta-information,” including the collection of stored information pertaining to an artifact that may originate from a single source or different sources. The consolidated meta-information may include, but is not limited or restricted to any or all of the following: (a) a portion of the distinctive metadata of the artifact (e.g., hash value, checksum, or other ID for an object), (b) one or more verdicts of the artifact, (c) a consolidated verdict, (d) information directed to the source of the artifact (e.g., source identifier, descriptor, serial number, type and/or model data, filename, version number, etc.) from which the artifact was first received and, where applicable, information from each subsequent source providing meta-information on the same artifact, (e) a timestamp associated with each verdict, and/or (f) other contextual information related to prior analyses and verdicts. Another type of meta-information may include uploaded meta-information provided to the cybersecurity intelligence hub from a cybersecurity sensor. This uploaded meta-information may include the portion of the distinctive metadata, source information (e.g., customer identifier, device identifier, etc.), information associated with an operating environment of the sensor or endpoint from which the artifact may have originated, and/or the timestamp.

The term “event” generally refers to a task or activity that is conducted by a software component running on the endpoint (virtual or real) and, in some situations, the activity may be undesired or unexpected indicating a potential cyber-attack is being attempted, such as a file being written to disk, a process being executed, or an attempted network connection. The event is monitored and logged for analysis, correlation and classification. A virtual endpoint includes a run-time environment that mimics, in some ways, that of a real endpoint, and is established within a virtual machine used to safely monitor one or more runtime activities for purposes of analysis for malware. Virtual endpoints are used, for example, by a cybersecurity appliance, located, for example, at a periphery of a network or operatively associated with an email server, to monitor network traffic and emails, respectively, for a cyber-attack. As an illustrative example, an event related to a particular activity performed by a process (e.g., process event) may be represented by distinctive metadata (described below), which may include a path identifying a location of an object being referenced by the process and an identifier of the object (e.g., hash value or checksum of the object). Likewise, an event related to an attempted or successful network connection may be represented by a destination (IP) address (DEST_IP), a source (IP) address (SRC_IP); and a destination port (DEST_PORT) associated with the network connection.

The term “object” generally refers to content having a logical structure or organization that enables it to be classified for purposes of analysis for malware. The content may include an executable (e.g., an application, program, code segment, a script, dynamic link library “dll” or any file in a format that can be directly executed by a computer such as a file with an “.exe” extension, etc.), a non-executable (e.g., a storage file; any document such as a Portable Document Format “PDF” document; a word processing document such as Word® document; an electronic mail “email” message, web page, etc.), or simply a collection of related data. According to one embodiment of the disclosure, the collection of related data may be data corresponding to a particular activity (event), such as a successful or unsuccessful logon or a successful or unsuccessful network connection attempt.

The term “message” generally refers to signaling (wired or wireless) as either information placed in a prescribed format and transmitted in accordance with a suitable delivery protocol or information made accessible through a logical data structure such as an API. Examples of the delivery protocol include, but are not limited or restricted to HTTP (Hypertext Transfer Protocol); HTTPS (HTTP Secure); Simple Mail Transfer Protocol (SMTP); File Transfer Protocol (FTP); iMES SAGE; Instant Message Access Protocol (IMAP); or the like. Hence, each message may be in the form of one or more packets, frames, or any other series of bits having the prescribed, structured format.

As described above, one type of message may be a request to retrieve stored, consolidated meta-information that may influence subsequent handling of an artifact under analysis. Another message type may include a query for stored, consolidated meta-information for a particular customer. Herein, the stored, consolidated meta-information includes a verdict that identifies a classification (e.g., benign, malicious, or unknown) of a prior evaluated artifact, a severity of the cyber-attack if the verdict is malicious, a textual recommendation to remediate the detected malware, etc.

As described above, each cybersecurity sensor may be deployed as a “physical” or “virtual” network device, as described above. Examples of a “cybersecurity sensor” may include, but are not limited or restricted to the following: (i) a cybersecurity appliance that monitors incoming and/or outgoing network traffic, emails, etc.; (ii) a firewall; (iii) a data transfer device (e.g., intermediary communication device, router, repeater, firewalls, portable mobile hotspot, etc.); (iv) a security information and event management system (“SIEM”) for aggregating information from a plurality of network devices, including without limitation endpoint devices; (v) an endpoint; (vi) a virtual device being software that supports data capture, preliminary analysis of data for malware, and meta-information extraction, including an anti-virus application or malware detection agent; or (v) exchange or web server equipped with malware detection software; or the like.

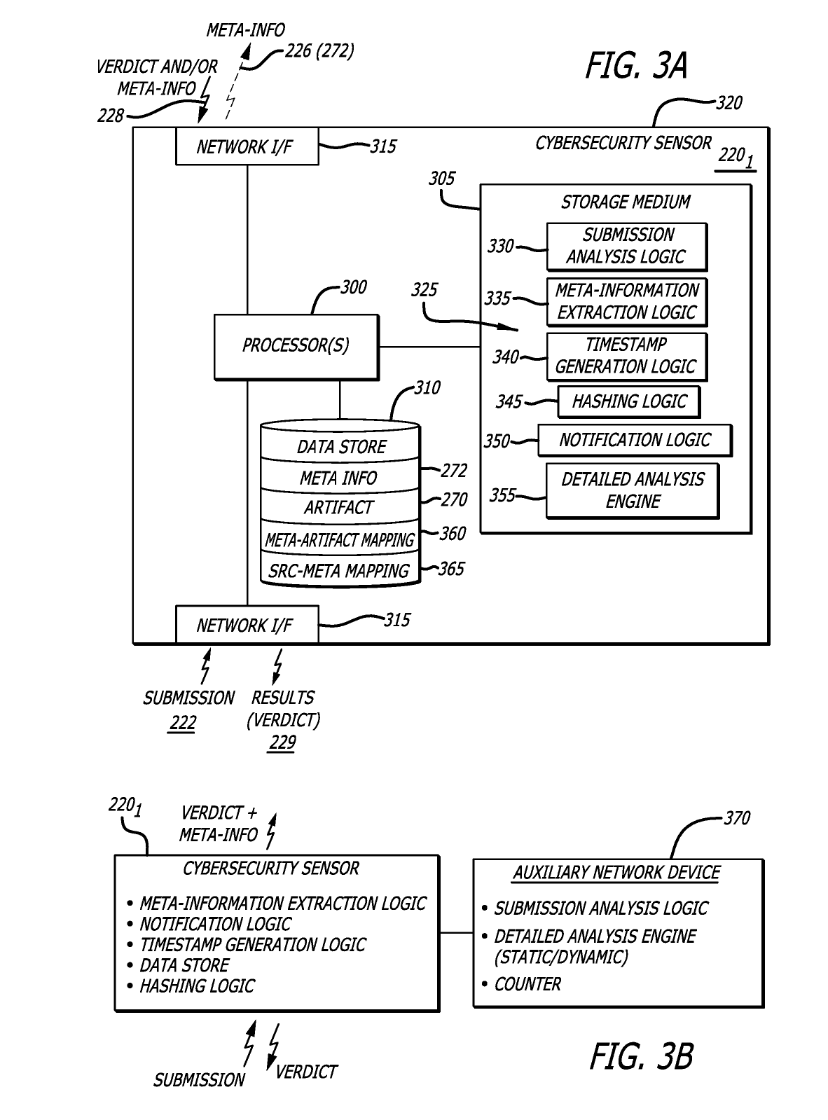

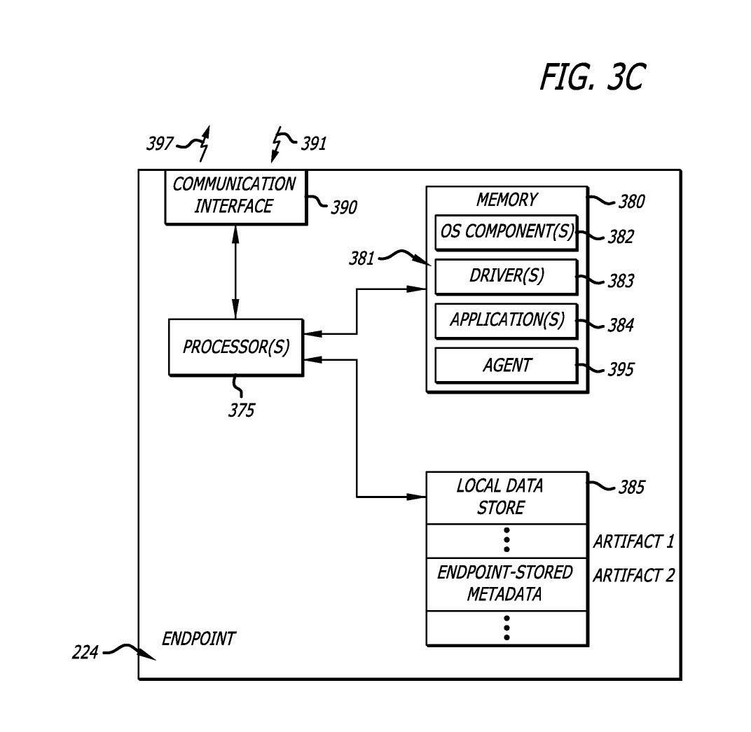

An “endpoint” generally refers to a physical or virtual network device equipped with a software image (e.g., operating system (OS), one or more applications), and a software agent to capture processing events (e.g. tasks or activities) in real-time for cybersecurity investigation or malware detection. Embodiments of an endpoint include, but are not limited or restricted to a laptop, a tablet, a netbook, a server, an industry or other controller, a set-top box, a device-installed mobile software and/or a management console. An illustrative embodiment of an endpoint is shown in FIG. 3C and described below.

A “plug-in” generally refers to a software component designed to add a specific functionality or capability to logic. The plug-in may be configured to communicate with the logic through an application program interface (API). The component can be readily customized or updated without modifying the logic. As used herein, the plug-in may encompass an add-on or extension, and may include implementations using shared libraries that can be dynamically loaded at run-time.

The term “computerized” generally represents that any corresponding operations are conducted by hardware in combination with software and/or firmware.

As briefly described above, the term “malware” may be broadly construed as malicious software that can cause a malicious communication or activity that initiates or furthers an attack (hereinafter, “cyber-attack”). Malware may prompt or cause unauthorized, unexpected, anomalous, unintended and/or unwanted behaviors (generally “attack-oriented behaviors”) or operations constituting a security compromise of information infrastructure. For instance, malware may correspond to a type of malicious computer code that, upon execution and as an illustrative example, takes advantage of a vulnerability in a network, network device or software, for example, to gain unauthorized access, harm or co-opt operation of a network device or misappropriate, modify or delete data. Alternatively, as another illustrative example, malware may correspond to information (e.g., executable code, script(s), data, command(s), etc.) that is designed to cause a network device to experience attack-oriented behaviors. The attack-oriented behaviors may include a communication-based anomaly or an execution-based anomaly, which, for example, could (1) alter the functionality of a network device in an atypical and unauthorized manner; and/or (2) provide unwanted functionality which may be generally acceptable in another context.

In certain instances, the terms “compare,” comparing,” “comparison,” or other tenses thereof generally mean determining if a match (e.g., identical or a prescribed level of correlation) is achieved between two items where one of the items may include content within meta-information associated with the artifact.

The term “transmission medium” generally refers to a physical or logical communication link (or path) between two or more network devices. For instance, as a physical communication path, wired and/or wireless interconnects in the form of electrical wiring, optical fiber, cable, bus trace, or a wireless channel using infrared, radio frequency (RF), may be used.

Finally, the terms “or” and “and/or” as used herein are to be interpreted as inclusive or meaning any one or any combination. As an example, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure is to be considered as an example of the principles of the invention and not intended to limit the invention to the specific embodiments shown and described.

### III. Comprehensive Cybersecurity Platform

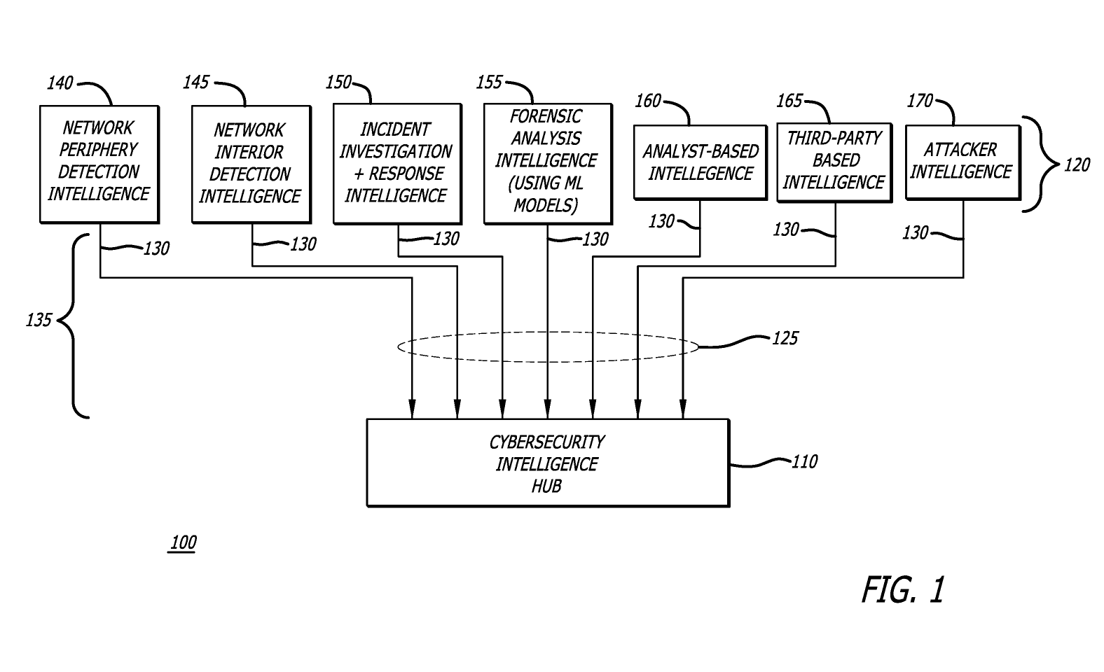

Referring to FIG. 1, a block diagram of an exemplary embodiment of a comprehensive cybersecurity platform (CCP) 100 is shown. Herein, the CCP 100 features a cybersecurity intelligence hub 110 and a plurality of cybersecurity intelligence sources (“sources”) 120. The cybersecurity intelligence hub 110 is configured to receive, parse, analyze and store, in a structured format within a global data store, cybersecurity intelligence from the sources 120. The cybersecurity intelligence may include meta-information associated with artifacts that have undergone prior malware analyses by cybersecurity sensors, incident responders or highly trained cybersecurity experts, as described above. These artifacts are referred to as “prior evaluated artifacts.” However, it is contemplated that the cybersecurity intelligence may include meta-information associated with detected artifacts that have not undergone prior malware analyses. The cybersecurity intelligence hub 110 is further configured to verify a “verdict” (e.g., a benign, malicious, or unknown classification) for an artifact based on analyses of one or more prior evaluated artifacts that match the artifact. Also, the cybersecurity intelligence hub 110 is configured to evaluate and/or generate additional cybersecurity intelligence for use in detecting campaigns, identifying trends, and/or retroactively modifying prior verdicts provided to consumers and later determined to be incorrect.

Herein, some or all of the cybersecurity intelligence hub 110 may be located at an enterprise's premises (e.g., located as any part of the enterprise's network infrastructure whether located at a single facility utilized by the enterprise or at a plurality of facilities). As an alternative embodiment, some or all of the cybersecurity intelligence hub 110 may be located outside the enterprise's network infrastructure and provided as a service over a public or private cloud-based services that may be hosted by a cybersecurity provider or another entity separate from the enterprise (service customer). For example, one of these embodiments may be a “hybrid” deployment, where the cybersecurity intelligence hub 110 may include some logic partially located on premises and other logic located as part of a cloud-based service. This separation allows for sensitive cybersecurity intelligence (e.g., proprietary intelligence learned from subscribing customers, etc.) to remain on premises for compliance with any privacy and regulatory requirements.

As further shown in FIG. 1, the cybersecurity intelligence sources 120 may supply cybersecurity intelligence 125 from various locations over transmission medium 130 forming a wired or wireless network 135. Delivered by the cybersecurity intelligence sources 120 using a push and/or pull communication schemes, the cybersecurity intelligence 125 may include, but is not limited or restricted to one or more of the following: (a) network periphery detection intelligence 140, (b) network interior detection intelligence 145, (c) incident investigation/response intelligence 150, (d) forensic analysis intelligence 155 using machine-learning models, (e) analyst-based intelligence 160, (f) third-party based intelligence 165, and/or (g) attacker intelligence 170.

More specifically, the cybersecurity intelligence 125 corresponds to malware analytics or information collected for such malware analytics. For instance, the network periphery detection intelligence 140 includes cybersecurity intelligence gathered from analyses of artifacts by an appliance, a firewall or other network devices that are monitoring network traffic to detect malicious intrusions into a protected network. The intelligence 140 may include URLs (email information), analyzed artifacts and/or meta-information associated with the analyzed artifacts. The network interior detection intelligence 145 includes cybersecurity intelligence gathered from analyses of artifacts by network devices connected within the network after passing the periphery (e.g., software agents within endpoints, email servers, etc.) in order to detect and gather meta-information associated with malicious operations occurring on devices within the network itself.

The incident investigation/response intelligence 150 includes cybersecurity intelligence gathered by cyber-attack incident investigators during analyses of successful attacks. This type of cybersecurity intelligence is useful for identifying the nature and source of a cyber-attack, how the identified malware gained entry on the network and/or into a particular network device connected to the network, history of the lateral spread of the malware during the cyber-attack, any remediation attempts conducted and the result of any attempts, and/or procedures to detect malware and prevent future attacks. Likewise, the forensic analysis intelligence 155 includes cybersecurity intelligence gathered by forensic analysts or machine-learning driven forensic engines, which is used to formulate models for use by certain types of cybersecurity sensors (e.g., appliances) in classifying an artifact as malicious or benign.

As further shown in FIG. 1, the analyst-based intelligence 160 includes cybersecurity intelligence gathered by highly-trained cybersecurity analysts, who analyze the detected malware to produce meta-information directed to its structure and code characteristics. The third-party based intelligence 165 includes cybersecurity intelligence gathered from reporting agencies and other cybersecurity providers, which may be company, industry or government centric. Lastly, the attacker intelligence 170 includes cybersecurity intelligence gathered on known parties that initiate cyber-attacks. Such cybersecurity intelligence may be directed to who are the attackers (e.g., name, location, etc.), whether state-sponsored attackers as well as common tools, technique and procedures used by a particular attacker that provide a better understanding typical intent of the cyber-attacker (e.g., product disruption, financial information exfiltration, etc.), and the general severity of cyber-attacks initiated by a particular attacker.

Collectively, some or all of these types of cybersecurity intelligence may be stored and organized within the cybersecurity intelligence hub 110 on an artifact basis, device basis, customer basis, or the like.

### IV. Cybersecurity Intelligence Hub

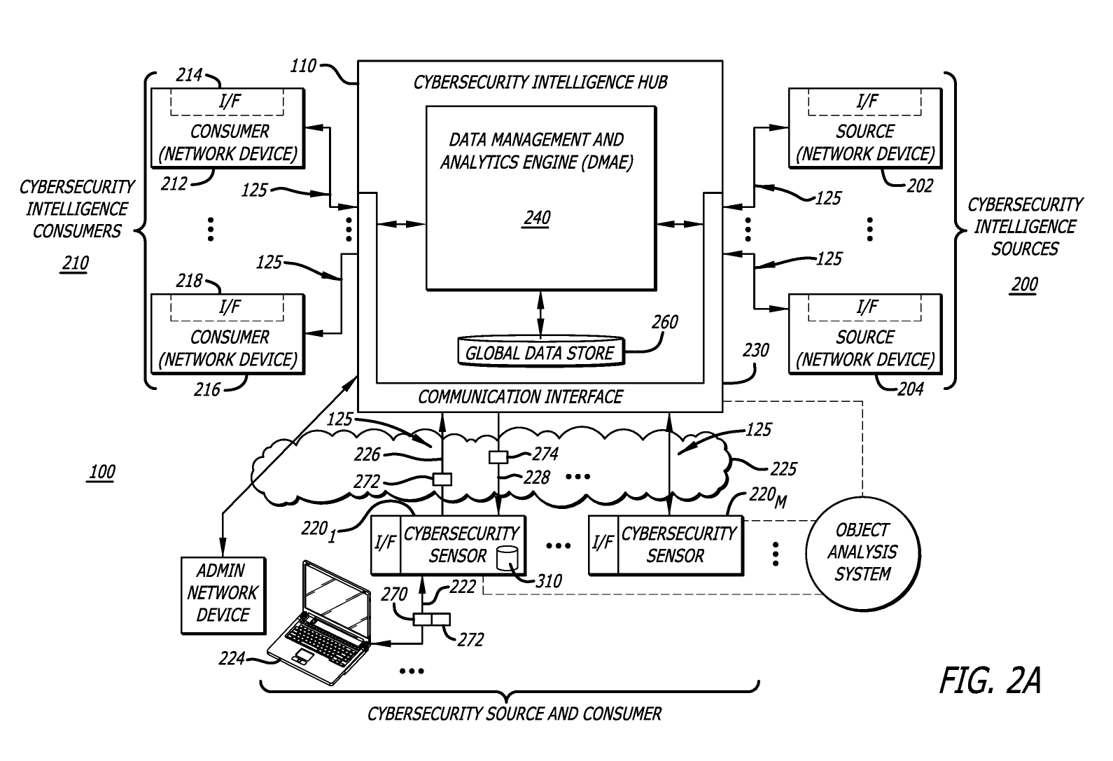

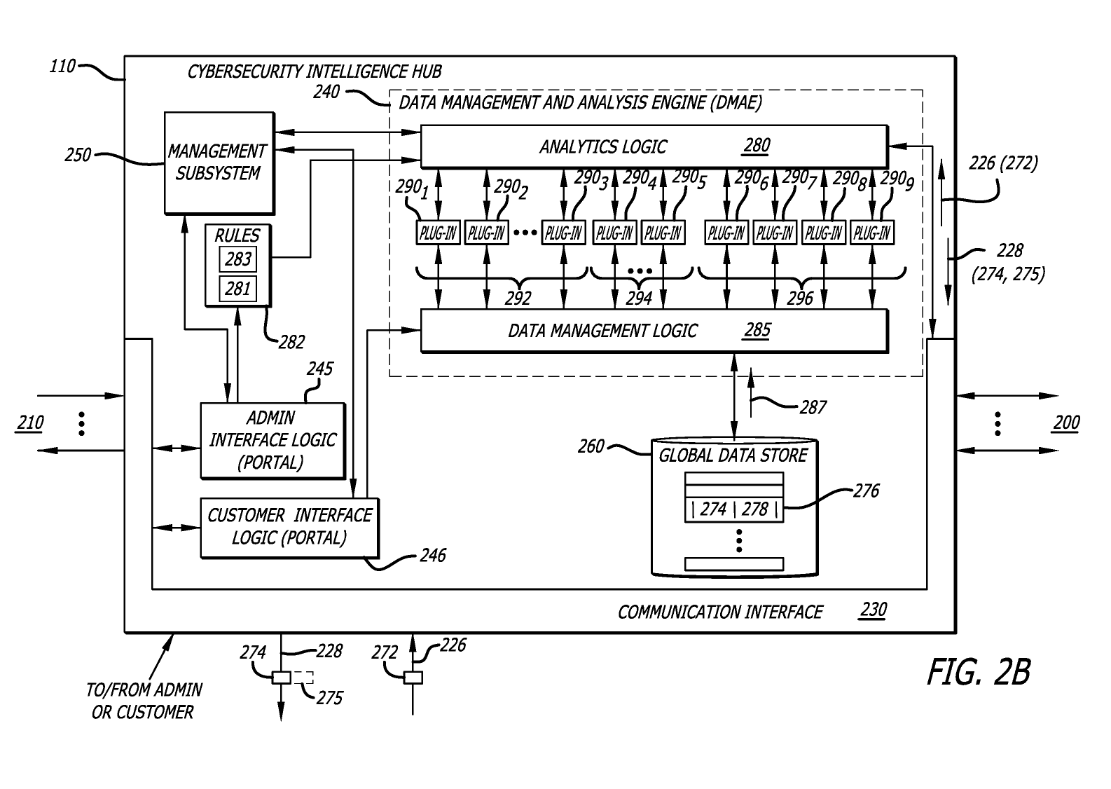

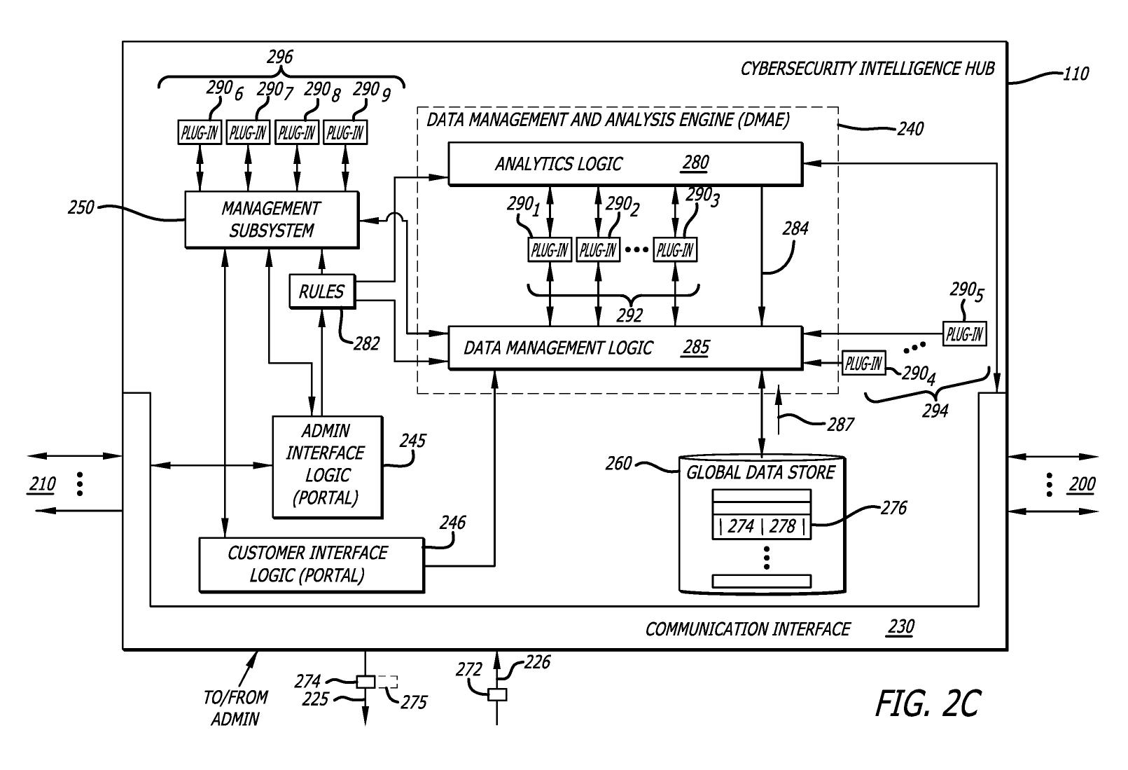

Referring now to FIG. 2A, an exemplary embodiment of the cybersecurity intelligence hub 110 of FIG. 1 is shown. The cybersecurity intelligence hub 110 is communicatively coupled to cybersecurity sources 200 and cybersecurity consumers 210 to receive cybersecurity intelligence therefrom. Depending on its operating state, each cybersecurity sensor 220₁-220_{M} may operate as a source 200 or as a consumer 210 of the cybersecurity intelligence. The cybersecurity intelligence hub 110 includes a communication interface 230, a data management and analytics engine (DMAE) 240, administrative interface logic (portal) 245, customer interface logic (portal) 246, a management subsystem 250, and/or a global data store 260, as collectively illustrated in FIGS. 2A-2C.

### A. Hub-Consumer/Source Connectivity

Referring to FIGS. 2A-2B, each of the sources 200 is configured to provide a portion of cybersecurity intelligence 125 to the cybersecurity intelligence hub 110 via the communication interface 230, where the portion of cybersecurity intelligence 125 is parsed by the DMAE 240 and placed into a structured format within the global data store 260 of the cybersecurity intelligence hub 110. The structured format of the cybersecurity intelligence 125 supports one or more indexing schemes organized by data type, artifact type (e.g., hash value of object), source type (e.g., original source or cybersecurity source), subscriber type (e.g., company, industry), geographic location (e.g., source IP address), the number of occurrence, or the like.

Each consumer 210 is configured to receive the cybersecurity intelligence 125 from the cybersecurity intelligence hub 110 via the communication interface 230. As shown, a first portion of the cybersecurity intelligence 125 may be returned in response to a request message provided from a first cybersecurity consumer (network device) 212 and observable via an user interface 214 (e.g., display screen, separate device with display capability, etc.) while a second portion of the cybersecurity intelligence 125 may be provided to a second cybersecurity consumer 216 and observable via the user interface 218 in response to a triggered event detected by the management subsystem 250 (e.g., scheduled time or a prescribed period of time has elapsed based on received time data from a clock source such as a real-time clock, a particular number of requests for analysis of meta-information associated with a particular artifact as maintained by a counter associated with each entry in the global data store 260, etc.). Herein, the second cybersecurity consumer 216 may be a server configured to support cybersecurity intelligence downloads with no capability to upload additional cybersecurity intelligence into the cybersecurity intelligence hub 110 (e.g., governmental entity, etc.) while the first cybersecurity consumer 212 may be configured as a server that operates as both a source and consumer.

### B. Hub-Sensor Connectivity

### 1. First Embodiment

As shown in FIG. 2A, each cybersecurity sensor 220₁-220_{M} (M>1), such as the cybersecurity sensor 220₁ for example, is configured to communicate with the cybersecurity intelligence hub 110 in response to receiving, for analysis, a submission 222 (e.g., meta-information 272 and/or artifact 270) from a network device 224. More specifically, according to one embodiment of the disclosure, where the artifact 270 is provided from the network device 224, the cybersecurity sensor 220₁ may conduct a static malware analysis of the artifact 270 to determine whether the artifact 270 is suspicious. In the alternative, or additionally performed serially or in parallel with the static malware analysis operations, the cybersecurity sensor 220₁ may perform an analysis by accessing metadata within a data store 310 of the cybersecurity sensor 220₁ and compare this metadata to certain metadata within the meta-information 272 that differentiate the artifact 270 from other artifacts (referred to as “distinctive metadata”). For example, this distinctive metadata may include an identifier (e.g., object ID) when the artifact associated with certain types of process events (e.g., open file, create file, write file, etc.) or an object itself. As another example, the distinctive metadata may consist of a source IP address, a destination IP address, and destination port when the artifact is an attempted network connection event.

Upon determining none of the contents within the data store 310 matches the distinctive metadata within the meta-information 272 (e.g., object ID), the cybersecurity sensor 220₁ sends a request message 226, including the meta-information 272 to the DMAE 240 of the cybersecurity intelligence hub 110. One type of request message 226 may be directed to determining whether the artifact 270 has been previously evaluated by prompting the DMAE 240 to compare the artifact ID, which may be represented as a hash value or checksum of the distinctive metadata (e.g., Object ID, address/port combination, etc.) to stored metadata of prior evaluated artifacts. If a match occurs, the cybersecurity intelligence hub 110 returns a response message 228, including a consolidated verdict 274 (classification) for the matched, prior evaluated artifact and additional meta-information associated with the consolidated verdict 274.

Responsive to receiving a “malicious” consolidated verdict for the artifact 270 from the DMAE 240, included as part of the consolidated meta-information associated with the matched prior evaluated artifact, the cybersecurity sensor 220₁ may (a) generate an alert a security administrator (of a network to which the network device 224 belongs) that the artifact 270 was previously determined to be malicious (e.g., in most cases, providing a portion of the consolidated meta-information as context) to enable action to be taken to remediate, interdict or neutralize the malware and/or halt its spread (e.g., within an enterprise network to which the network device 224 connects), and/or (b) initiate further analysis of the artifact 270 to acquire additional meta-information including its characteristics and/or behaviors and its present context (e.g., state information, software profile, timestamp, etc.) to subsequently upload into the global data store 260.

In response to receiving a “benign” consolidated verdict, the cybersecurity sensor 220₁ may terminate further analysis of the artifact. In response to receiving an “unknown” consolidated verdict, however, the cybersecurity sensor 220₁ may determine to initiate further analysis as described above, where the unknown consolidated verdict indicates no entry in the global data store 260 is present for the artifact or the entry indicates the artifact has been analyzed previously but with inconclusive results (e.g., not having satisfied benign or maliciousness thresholds, or the verdict count threshold has not been exceeded). Accordingly, based on the consolidated verdict, redundant analyses of the artifact may be avoided.

As an illustrative example, upon receiving the artifact 270 from the network device 224, the cybersecurity sensor 220₁ conducts a static malware analysis of the artifact 270 to determine whether the artifact is suspicious. Furthermore, operating in parallel with the static malware analysis, the cybersecurity sensor 220₁ performs an analysis by accessing metadata within a data store 310 of the cybersecurity sensor 220₁ and comparing the metadata to the distinctive metadata within the meta-information 272 (e.g., object ID). Based on this comparison, the cybersecurity sensor 220₁ can determine whether the artifact 270 has been previously analyzed by the cybersecurity intelligence hub 110 via the cybersecurity sensor 220₁. Upon confirming the artifact 270 has not been previously analyzed by the cybersecurity intelligence hub 110, at least the meta-information 272 is included as part of the request message 226 provided to the cybersecurity intelligence hub 110.

As described above, the global data store 260 is accessed via the cybersecurity sensor 220₁. Additionally, the global data store 260 may be accessed by a platform administrator via an administrative portal 245 or by a consumer 210 (e.g. a customer) directly or via a customer portal 246 of FIG. 2B, permitting and controlling external access to the cybersecurity intelligence hub 110. In particular, the administrative portal 245 may be used to configure rules (e.g., modify, delete, add rules such as consolidated verdict determination rules or analysis ordering rules) and allow an administrator to run queries to receive and organize cybersecurity intelligence from the global data store 260 for display. The customer portal 246 may be used to issue queries and access cybersecurity intelligence associated with that customer within the global data store (via the data management logic 285). The cybersecurity intelligence may be used, for example, in enhanced detection, remediation, investigation and reporting. The type of amount of cybersecurity intelligence made available to the administrator via the administrative portal 245 may exceed the amount of data made available to the customer via the customer portal 246.

In various embodiments, the cybersecurity sensor 220₁ accesses the cybersecurity intelligence on a “push” or “pull” basis. Moreover, the cybersecurity intelligence can be furnished as general updates to the cybersecurity sensor 220₁ (or other consumers 210) based on consumer type, subscription type when access to the cybersecurity intelligence hub is controlled by subscription (e.g., different levels of access, different quality of service “QoS”, etc.), or the type of information that the consumer 210 (or its enterprise/subscribing customer) may find useful. Alternatively, the cybersecurity intelligence can be accessed by the cybersecurity sensor 220₁ (or other consumers 210 via an interface logic) to “pull” intelligence relevant to a particular detection, remediation, or investigation, for example, to provide context and other information regarding specific actual or potential cyber-attacks. For this, the global data store 260 can be accessed by the cybersecurity sensor 220₁ (or other consumers 210), for example, using a hash value, checksum or other distinctive metadata associated with the artifact as a look-up index to obtain consolidated meta-information regarding the artifact (whether identified as malicious, benign or unknown).

### 2. Second Embodiment

Alternatively, according to another embodiment of the disclosure, it is contemplated that a preliminary malware analysis of the artifact 270 may be conducted by the network device 224 (e.g., an endpoint) in lieu of the cybersecurity sensor 220₁. Hence, for this embodiment, the network device 224 sends meta-information 272 to the cybersecurity sensor 220₁, and the cybersecurity sensor 220₁ does not perform any static or behavioral analyses on the artifact 270. Rather, the cybersecurity sensor 220₁ is performing correlation across detected meta-information (e.g., events, objects, etc.) that are reported from multiple agents to the cybersecurity sensor 220₁ supporting these agents. The distinctive metadata (e.g., object ID) from the meta-information 272 may be used in controlling what meta-information is uploaded to the cybersecurity intelligence hub 110 as described above. As a result, depending on the embodiment, a cybersecurity sensor can be designed to perform (a) aggregation of artifacts found by other network devices, with or without correlation across artifacts and/or devices, and with or without further analysis and, in some cases, classification to generate a verdict, or (b) detection of artifacts itself (e.g., in network traffic, emails or other content), with or without further analysis and, in some cases, classification to generate a verdict.

### C. Data Management and Analysis Engine (DMAE)

As shown in FIGS. 2A-2B, for this embodiment of the disclosure, the DMAE 240 includes an analytics logic 280, data management logic 285 and a plurality of plug-ins 290₁-290_{N} (N>1) communicatively coupled to and registered with the analytics logic 280. Each plug-in 290₁-290_{N} may provide the DMAE 240 with a different configurable and updateable functionality. Moreover, at least some of the plurality of plug-ins 290₁-290_{N} may be in communication with each other, notably where analysis results produced by one plug-in operate as an input for another plug-in.

In accordance with one embodiment of the disclosure, via communication interface 230, the analytics logic 280 receives request messages for cybersecurity intelligence from the consumers 210, including the cybersecurity sensors 220₁-220_{M}. The analytics logic 280 parses the request message 226, and based on its type and/or content within the meta-information 272, determines one or more plug-ins to process the request message 226. More specifically, according to one embodiment of the disclosure, the analytics logic 280 is communicatively coupled to a plurality of software modules (e.g., plug-ins) installed within the DMAE 240 to assist in responding to the request messages. Herein, for this embodiment, the analytics logic 280 parses the request message 226 to obtain at least a portion of the meta-information (e.g., distinctive metadata), selects one or more plug-ins 290₁, . . . , or 296_{N} to receive the portion of the meta-information, receives results from the one or more plug-ins 290₁, . . . , or 296_{N}, and processes the results to determine the consolidated verdict in accordance with analytic rules 282, including consolidated verdict determination rules 283.

The consolidated verdict determination rules 283 may be static (e.g., no known consolidated verdict selected unless all known verdicts are consistent) or may be configurable. Examples of these configurable rules 283 for use in selecting a particular classification for the consolidated verdict may include, but are not limited or restricted to the following: (i) a source-based analysis where the consolidated verdict is selected as the verdict provided from the most reliable source (e.g., analyst; blacklist; dynamic analysis results; . . . third party results . . . ); (ii) weighted analysis where the consolidated verdict is selected based on a weighting of one or more factors, including (a) source of verdict (e.g., most reliable and thus associated with a higher weight), (b) configuration of the requesting network device (e.g., security level, enabled features, GUI type, OS type, etc.) (e.g., where the configuration closest to that of interest to a customer is associated with a higher weight), (c) type of analysis conducted to render the verdict (e.g., where certain analysis may be deemed more reliable and be associated with a higher weight), (d) time of verdict determination (e.g., where more recent verdict or a group of two or more consistent recent verdicts (e.g., regardless of inconsistent prior verdicts) may be deemed more reliable and be associated with a higher weight), (e) geographic origin of the artifact associated with the verdict (e.g., where certain locations may be deemed associated with a higher weight), or the like; or (iii) a time-based analysis where the consolidated verdict is set to an “unknown” classification upon determining that one verdict or multiple verdicts are aged longer than a prescribed duration, and thus, may cause an additional detailed analysis to be conducted on the artifact that the results of the analysis may be returned to the global data store to overwrite an aged entry.

It is contemplated that the analytics logic 280 is configured to select (invoke) the one or more plug-ins for processing of a request message (request or query) in accordance with a prescribed order, based on a request type and meta-information, or based on results of a prior analysis by a plug-in. More specifically, one selection process may involve the analytics logic first selecting an available plug-in with highest accuracy (confidence) level (e.g., blacklist plug-in, whitelist plug-in, etc.) and the request is processed over a number of plug-ins according to the latency demands for the return of a consolidated verdict. Additionally, the analytics logic may be configured to analyze portions of the meta-information within the request or portions of analysis results from another plug-in to determine a next plug-in to invoke as further analysis is needed to render a consolidated verdict. The selection of the next plug-in may be in accordance with analysis ordering rules, which may be configurable and/or stored with the consolidated verdict determination rules.

According to another embodiment of the disclosure, the analytics logic 280 may be configured to also analyze the received, consolidated meta-information in accordance with the consolidated verdict determination rules 283 described above. Some of these rules 283 may be coded to preclude the return of a requested verdict unless a prescribed number of analysis results conclude the same, consistent verdict from the same source or from different sources. The analytics logic 280 performs such operations to mitigate false positive/negative results due to, for example, insufficient intelligence and/or conflicting verdicts. Conflicting verdicts may be especially prevalent as malware analyses may be performed with different operating systems (OSes), different application versions, or the like, which may contain different types or levels of vulnerabilities exploitable by cyber-attackers.

As an illustrative example, the cybersecurity sensor 220₁ of FIG. 1 may be configured to send the request message 226 corresponding to a verification request to re-confirm the verdict associated with the artifact 270. Responsive to receiving the verification request message 226, the analytics logic 280 parses the request message 226 and determines one or more plug-ins (e.g., plug-ins 290₁ and/or 290₂) to handle the verification request. For this embodiment, the plurality of plug-ins 290₁-290_{N} may include a first set (one or more) of plug-ins 292 to handle low-latency requests (e.g., response time with a maximum latency less than or equal to a prescribed duration such as less than a few seconds), a second set of plug-ins 294 to handle requests other than low-latency requests, and a third set of plug-ins 296 may operate in the background to generate additional cybersecurity intelligence for enhancing cyber-attack detection and response. The management subsystem 250 monitors for a triggering event, and upon detection, activates one or more of the third set of plug-ins 296 via the analytics logic 280. These plug-ins 296 are selectively activated based on the operation to be conducted (e.g., trend analysis, campaign detection, retroactive reclassification, etc.).

Additionally, or in the alternative, the plurality of plug-ins 290₁-290_{N} may be segmented so that the first set of plug-ins 292 is configured to handle operations associated with a first artifact type (e.g., executables) while the second set of plug-ins 294 and/or the third set of plug-ins 296 are configured to handle operations associated with artifact types different than the first artifact type (e.g., non-executables such as Portable Document Format “PDF” documents, word processing documents, files, etc.). The data management logic 285 is configured to manage organization (e.g., normalize data into a selected data structure, updating index mapping tables, etc.), retrieval (read) and storage (write) of the cybersecurity intelligence within the global data store 260.

As another illustrative embodiment, the cybersecurity intelligence hub 110 may be configured to receive the request message 226 via a network 225 from the cybersecurity sensor 220₁. Responsive to the request message 226 being directed to a low-latency operation (e.g., verifying a verdict associated with an artifact under analysis), the analytics logic 280 may select a single plug-in or multiple plug-ins operating in a serial or parallel manner (e.g., plug-ins 290₁-290₃) from the first set of plug-ins 292. The selected plug-in(s) (e.g., plug-in 290₁) signals the data management logic 285 to check the global data store 260 for an entry 276 for that particular artifact. Upon locating the entry 276, the data management logic 285 retrieves meta-information 287 from the entry (e.g., verdict 274 and perhaps other meta-information 278 associated with the prior evaluated artifact such as source, software profile utilized for analysis, timestamp, etc.) and provides the retrieved meta-information 287 to the selected plug-in 290₁.

Thereafter, according to one embodiment of the disclosure, the selected plug-in 290₁ returns, via the analytics logic 280, at least a portion of the meta-information 287 to the requesting cybersecurity sensor 220₁. During this verification operation, the analytics logic 280 tracks the request message 226 (and the requesting sensor 220₁) and may cause the communication session through the communication interface 230 to remain open so that a response may be provided during the same communication session. Such tracking may be accomplished through a mapping table or another similar data structure (not shown).

According to another embodiment of the disclosure, instead of simply controlling communications between the selected plug-in 290₁ and the data management logic 285, the analytics logic 280 may be configured to analyze the retrieved meta-information 287 in accordance with a plurality of analytic rules 282 that govern operability of the analytics logic 280 and are updatable via the administrative portal 245. More specifically, the plurality of analytic rules 282 include consolidated verdict determination rules 283 and analysis ordering rules 281. The analytics logic 280 operates in accordance with the consolidated verdict determination rules 283 to generate a consolidated verdict for an artifact associated with meta-information provided with the request message 226. The analytics logic 280 may further operate in accordance with the analysis ordering rules 281 that may identify an order in processing of the meta-information 272 (and the resultant analysis results) by the registered plug-ins 290₁-290_{N}.

Herein, illustrated as part of the analytic rules 282, the consolidated verdict determination rules 283 may be static or configurable (e.g., via administrative portal 245). Where the consolidated verdict determination rules 283 promote a source-based analysis, the analytics logic 280 may determine a particular classification for the consolidated verdict based on the verdict provided from the most reliable source (or analysis). For example, where the selected plug-in 290₁ recovers five (5) verdicts, where some of the verdicts are third party sources of a less reliable nature and one verdict is from full dynamic analysis by a cybersecurity sensor, the configurable rules 283 may be coded to select the consolidated verdict associated with the dynamic analysis verdict. Alternatively, the configurable rules may be directed to a weighting operation, where weightings for each of the five verdicts are provided and the consolidated verdict is based on the known verdict (malicious or benign) having the largest collective weighting or some other statistically relevant basis (e.g., average weighting, etc.). Alternatively, the weighted analysis may take into account other factors besides the verdict such as (a) the source of verdict, (b) the configuration of the requesting network device (e.g., security level, enabled features, run-time environment, OS type, etc.), (c) the type of analysis conducted to render the verdict, (d) the time of verdict determination, (e) the geographic origin of the artifact associated with the verdict, or the like.

Herein, the analytic rules 282 may further preclude the return of a “malicious” or “benign” verdict when a number of prior analyses (which may be from one or more sensors) reaching the same, consistent verdict falls below a prescribed verdict count threshold (e.g., two or more consistent verdicts, at least ten consistent verdicts, etc.). Some embodiments may use a first count threshold for consistent malicious verdicts and a higher second count threshold for a benign consistent verdict. Hence, before returning at least the portion of meta-information 287 to the requesting cybersecurity sensor 220₁, the analytics logic 280 alters the meta-information 287 by setting the verdict as “unknown”.

As another example, the analytic rules 282 may preclude the return of a “malicious” or “benign” verdict in response to conflicting verdicts by considering contextual information (e.g., software profile, source, timestamp, etc.) in reaching its consolidated verdict for return to the cybersecurity sensor 220₁, which may be at odds with the prior system-specific verdicts. For example, if the prior analyses all examined the artifact's behaviors in a software environment including an OSX® operating system (OS) and applications running thereon, but the requesting cybersecurity sensor 220₁ is encountering the artifact within a different software environment, such as a Windows® OS, the consolidated verdict may indicate an “unknown” (or “indefinite”) status and/or may simply give a recommendation 275 for further analysis in the Windows® environment. The recommendation 275 from the analytics logic 280 may advise on a heightened or lower risk of maliciousness. For a heightened risk, further analysis of the artifact 270 may be warranted or even immediate remedial action may be appropriate. For a lower risk, the requesting cybersecurity sensor 220₁ may terminate an in-process malware analysis (or a scheduled malware analysis).

Although not shown, as an alternative embodiment, in lieu of accessing the global data store 260 via the data management logic 285, one or more of the plug-ins 290₁-290_{N} may directly access the global data store 260. Herein, the one or more of the plug-ins 290₁-290_{N} would obtain the cybersecurity intelligence for enhanced detection functionality by receipt of a prior verdict as a definitive finding of an artifact's benign or malicious classification or as additional classification information used in subsequent analysis and classification of the artifact 270.

In various embodiments, the cybersecurity intelligence (e.g., meta-information within response message 228) can be furnished to the requesting cybersecurity sensor 220₁ (or other consumers) on a “push” or “pull” basis. Moreover, the type and amount of cybersecurity intelligence can be furnished to the cybersecurity sensor 220₁ (or other consumers) based on customer type, subscription type, geographic restrictions, or other types of information that the consumer (or its enterprise/subscribing customer) may find useful. The cybersecurity intelligence may constitute general updates to locally stored cybersecurity intelligence at the cybersecurity sensor 220₁. Alternatively, the cybersecurity intelligence can be accessed by the cybersecurity sensor 220₁ (or other consumers) to “pull” meta-information from the cybersecurity intelligence hub 110 relevant to a particular detection, remediation, or investigation, for example, to provide context and other information regarding specific actual or potential cyber-attacks.

For example, where an artifact is initially determined to be benign by a first source 202, and subsequently classified as malicious by a second source 204 conducting a later and/or more in-depth analysis, the cybersecurity intelligence hub 110 may provide updated meta-information (e.g., corrected verdict) to the cybersecurity sensor 220₁ to retroactively re-classify the artifact 270 as malicious and notify any customers that received the benign verdict for the artifact 270 with the corrected verdict. As a first illustrative example, the retroactive re-classification may occur based on the second source 204 performing a behavioral malware analysis while the first source 202 may have relied on static malware analysis. As a second illustrative example, both the first and second sources 202 and 204 may perform a behavioral malware analysis, but using different software images resulting in different classifications (for example, where the second source 204 uses a software image with software vulnerable to an exploit). As another illustrative example, the retroactive re-classification may occur when the second source 204 performs behavioral analyses based on a different (and more advanced) set of rules than the rule set utilized by the first source 202. This re-classification operation may be performed by a re-classification plug-in (described below).

### D. Illustrative Plug-Ins

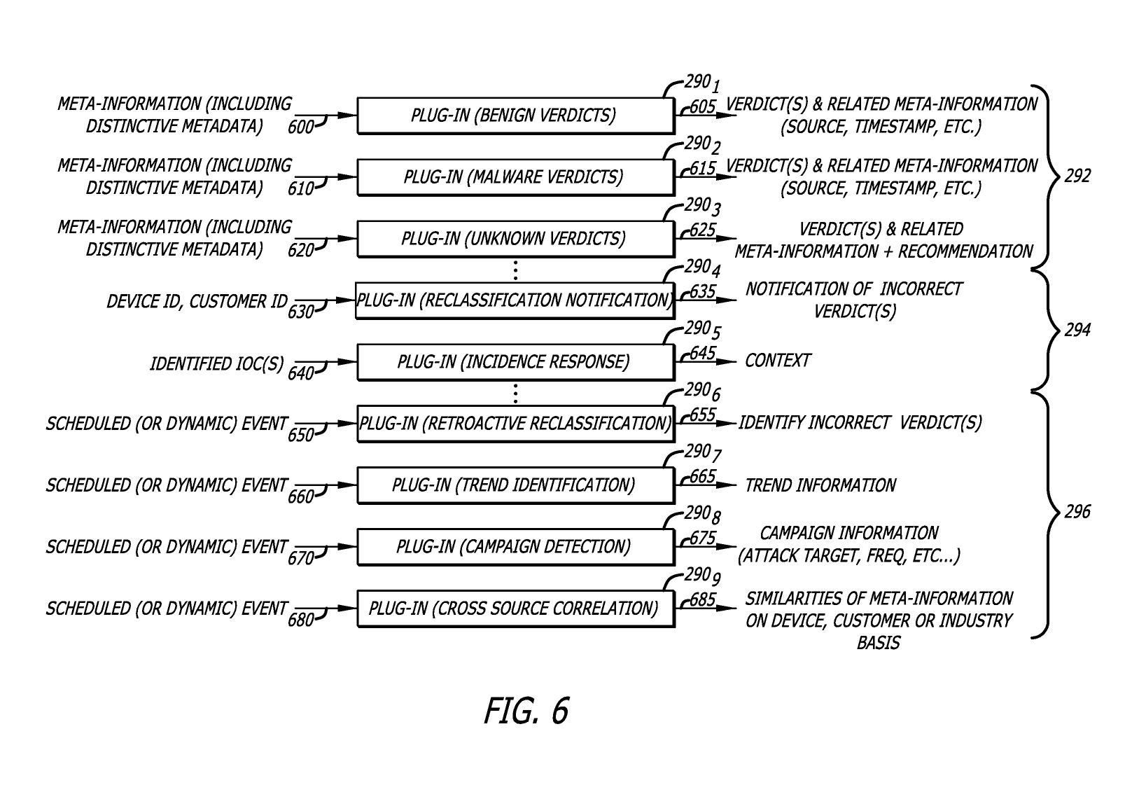

As an illustrative example, the plurality of plug-ins 290₁-290_{N} are deployed within the cybersecurity intelligence hub 110 and are registered as a member to one of the sets of plug-ins (e.g., first set 292 and second set 294). The registration may be used to identify the logic to which the additional functionality is directed (e.g., plug-ins for handling low-latency requests, plug-ins for handling normal or even high latency requests, etc.). The third set of plug-ins 296 is not request-driven; rather, these plug-ins 296 are activated in response to a triggering event (e.g., scheduled or dynamic event). It is contemplated, however, that certain plug-ins from the second set of plug-ins 294 may be configured for operation as a plug-in for the third set of plug-ins 296 and vice versa. Illustrative examples of different plug-in types, where each of these plug-ins may operate independently or in parallel with any other plug-in, are illustrated in FIG. 6 and described below.

### E. Secondary Embodiment—Cybersecurity Intelligence Hub

Referring now to FIG. 2C, a second exemplary embodiment of the cybersecurity intelligence hub 110 of FIG. 1 is shown. Depending on its functionality, the plurality of plug-ins 290₁-290_{N} may be segmented among the analytics logic 280, the data management logic 285, and the management subsystem 250. For instance, the first set of plug-ins 292 may be directly coupled to the analytics logic 280 to handle time-sensitive requests while the second set of plug-ins 294 may be directly coupled to the data management logic 285 to handle requests directed to gathering cybersecurity intelligence (stored meta-information) that is less time-sensitive (e.g., stored meta-information for updating purposes, etc.). Of course, certain plug-ins of the first set of plug-ins 292 may be communicatively coupled with other plug-ins within the first set of plug-ins 292 or the second set of plug-ins 294 for conducting a more expansive analysis, when needed.

Additionally, according to another embodiment of the disclosure, operating with the DMAE 240, the management subsystem 250 of the cybersecurity intelligence hub 110 may be communicatively coupled to the third set of plug-ins 296, which are configured to generate additional cybersecurity intelligence based on analyses of stored cybersecurity intelligence within the global data store 260. In response to a triggering event, the management subsystem 250 invokes one or more plug-ins of the third set of plug-ins (e.g., plug-ins 290₆-290₉), which is configured to retrieve stored cybersecurity intelligence within the global data store 260 via the data management logic 285 and generate additional cybersecurity intelligence. The additional cybersecurity intelligence may be stored in the global data store 260. Hence, the cybersecurity intelligence hub 110 can be leveraged to provide more effective protection against cyber-attacks.

In the event that the management subsystem 250, analytics logic 280 and the data management logic 285 monitor the reliability of the verdict based on count (e.g., the number of analyses conducted for a particular artifact), the analytic rules 282 are accessible to each of these components. However, the analytics logic 280 still may categorize all request messages received from the cybersecurity sensor 220₁ and pass those request messages handled by the second set of plug-ins 294 to the data management logic 285 via logical path 284.

For instance, as described above and illustrated in FIGS. 2A-2C, the trend plug-ins 290₇ is configured to analyze the stored meta-information within the global data store 260 for cyber-attack trends across enterprises, industries, government agencies, or geographic locations while the campaign plug-ins 290₈ is configured to identify targeted and deliberate cyber-attacks based on repetitious attempts, e.g., to infiltrate and disrupt operations of a targeted network device and/or exfiltrate data therefrom, where the campaigns may be detected for a particular victim by one or more sensors of a single customer or by sensors serving customers across an industry, geography, or computing environment (e.g., operating system, version number, etc.). Such analysis assists in predicting (and warning) of potential or hidden, but on-going, cyber-attacks based on historical information. Also, the correlation plug-in 290₉ may be configured to perform a correlation operation across the stored cybersecurity intelligence related to an artifact, or even across a plurality of artifacts to develop consolidated meta-information (results) to identify sophisticated cyber-attacks targeting different network devices, networks or customers associated with different cybersecurity sensors, as described below.

In yet another inventive aspect, the exchanges between the cybersecurity intelligence hub 110 and the consumers 210 and 220₁-220_{N} may cause a consumer (e.g., cybersecurity sensor 220₁) to take action in response to the supplied cybersecurity intelligence 125. For example, where cybersecurity sensor 220₁ receives the cybersecurity intelligence relevant to a recently received artifact that has been determined by a second cybersecurity sensor 220_{N} to be malicious, the cybersecurity sensor 220₁ may (1) queue the artifact 270 in question for priority/immediate deep analysis, and/or (2) issue an immediate alert. The cybersecurity intelligence generated in response to the analysis of the consolidated meta-information may be translated into heuristic rules, signatures, and/or other identifiers that may be distributed by the cybersecurity intelligence hub 110 to some or all of the sources and consumers, especially the community of cybersecurity sensors 220₁-220_{N}, for use in identifying malicious artifacts and preventing such artifacts from executing on or laterally moving from the cybersecurity sensor 220₁.

Additionally, where the cybersecurity sensor 220₁ receives meta-information from the DMAE 240 that warrants issuance or initiation of an alert, the cybersecurity sensor 220₁ also may implement a more robust protection regime. This may occur, for example, during a high threat situation, e.g., a cyber conflict, public infrastructure attack, political election (e.g., targeting an election commission, etc.). It may also occur when the DMAE 240 identifies a new threat type (e.g., new type of malware, for example, carried by a particular file type, exploiting a new version of an operating system or application, or directed at a particular industry or government).

As shown in FIGS. 2B-2C, via the administrative portal 245 and management subsystem 250, authorized administrators and cybersecurity providers may upload meta-information into the global data store 260 and conduct searches for certain stored meta-information within the global data store 260. As an example, a security administrator may initiate a query in accordance with a selected search syntax to retrieve reclassified verdicts as described herein, meta-information associated with certain artifact types (e.g., executables, particular type of non-executable, etc.) stored into the global data store 260 during a predetermined period of time, or the like. Customers may conduct similar queries with results directed to that particular customer (and not platform-wide).

As another example, incident responders to a cyber-attack may identify a certain type of artifact (e.g., indicators of compromise “IOCs”) in a network. However, by comparing to the meta-information associated with the IOCs in the global data store 260, whether by searching for an object ID (e.g., hash value) or by IOCs ID (e.g., identifying behaviors), it is contemplated that additional metadata (in lieu of or in addition to the IOCs) may be returned as an enhanced report. The enhanced report may include any connection to malicious websites, additional IOCs in the global data store 260 that may assist in identifying lateral of malware (and the amount of lateral spread), common name of detected malware, or the like. For this embodiment, the request message sent by the cybersecurity provider (incident responder) to the cybersecurity intelligence hub 110 may identify a single IOC or a plurality (or pattern) of IOCs, which are used as an index to identify an entry in the global data store 260.

The analytics logic 280 may identify and return consolidated meta-information within the single entry or plural entries in the global data store 260, each entry containing information regarding previously encountered incidents exhibiting IOCs having a correlation (equal to or above a prescribed level of correlation) with the requested IOCs. The returned cybersecurity information may include the verdict (if any) included in those entries. The returned cybersecurity information can be used by the incident responder for various purposes, such as to guide further investigations (e.g., by specifying IOCs that have previously been known to accompany those included in the request but were not yet observed for the current incident).

Referring now to FIG. 3A, a first exemplary embodiment of the logical architecture of the cybersecurity sensor 220₁ deployed within the comprehensive cybersecurity platform (CCP) 100 of FIG. 1 is shown. According to this embodiment of the disclosure, the cybersecurity sensor 220₁ comprises a plurality of components, including one or more hardware processors 300 (referred to as “processor(s)”), a non-transitory storage medium 305, a data store 310, and one or more network interfaces 315 (each referred to as “network OF”). Herein, when the cybersecurity sensor 220₁ is a physical network device, these components are at least partially encased in a housing 320, which may be made entirely or partially of a rigid material (e.g., hard plastic, metal, glass, composites, or any combination thereof) that protects these components from environmental conditions.

In an alternative virtual device deployment, however, the cybersecurity sensor 220₁ may be implemented entirely as software that may be loaded into a network device (as shown) and operated in cooperation with an operating system (“OS”) running on that device. For this implementation, the architecture of the software-based cybersecurity sensor 220₁ includes software modules that, when executed by a processor, perform functions directed to functionality of logic 325 illustrated within the storage medium 305, as described below. As described below, the logic 325 may include, but is not limited or restricted to, (i) submission analysis logic 330, (ii) meta-information extraction logic 335, (iii) timestamp generation logic 340, (iv) hashing (or checksum) logic 345, (v) notification logic 350, and/or (vi) detailed analysis engine 355.

The processor 300 is a multi-purpose, processing component that is configured to execute logic 325 maintained within the non-transitory storage medium 305 operating as a memory. One example of processor 300 includes an Intel® (x86) central processing unit (CPU) with an instruction set architecture. Alternatively, processor 300 may include another type of CPUs, a digital signal processor, an Application Specific Integrated Circuit (ASIC), a field-programmable gate array, or any other hardware component with data processing capability.

As shown, the network interface(s) 315 may be configured to receive a submission 222, including at least the meta-information 272, from the network device 224. The meta-information 272 and/or artifact 270 may be stored within the data store 310 prior to processing. It is contemplated that the artifact 270 corresponding to the meta-information 272 may be requested by the cybersecurity sensor 220₁ and cybersecurity intelligence hub 110 when the artifact 270 is needed by the cybersecurity intelligence hub 110 to determine verdict. A mapping between the meta-information 272 and the artifact 270 (referred to as “Meta-Artifact mapping 360”) is maintained by the cybersecurity sensor 220₁ and stored within the data store 310. More specifically, the mapping 360 may be accomplished by assigning a distinct identifier to the meta-information 272 and the artifact 270 pairing. It is further contemplated that source-to-meta-information (SRC-Meta) mapping 365 may be utilized to identify the source of the meta-information 272 to return verdicts, discern target (among the customers including the “requesting customer” for alerts concerning artifacts associated with the submitted meta-information 272, and the like.

Referring still to FIG. 3A, the processor(s) 300 processes the meta-information extraction logic 335 which, during such processing, extracts the meta-information 272 from the received submission 222. Additionally, the processor(s) 300 processes the timestamp generation logic 340 to generate a timestamp that generally represents a time of receipt of the meta-information 272 (and artifact 270 if provided), although it is contemplated that the timestamp generation logic 340 is optional logic as the timestamp may be generated at the network device 224. Where the artifact 270 is provided with the submission 222, the processor(s) 300 process the submission analysis logic 330, which conducts an analysis of at least a portion of the submission 222, such as the artifact 270 for example, to determine whether the artifact 270 is suspicious. As another optional component, the hashing logic 345 may be available to the processor(s) 300 to produce a hash value of the artifact 270 for storage as part of the meta-information 272, provided the hash value is not already provided as part of the meta-information 272.

The meta-information 272 (and/or artifact 270) may be temporarily stored and accessible for use in determining whether the artifact 270 has been previously analyzed. The determination may be accomplished by comparing distinctive metadata within the meta-information 272, which may be identified in meta-information provided from the endpoint 224 (e.g., tagged, stored in a particular location within the data structure of the meta-information 272, etc.), to locally stored meta-information associated with prior evaluated artifacts (referred to as “prior meta-information”).

As further shown in FIG. 3A, the cybersecurity sensor 220₁ is configured to transmit a first type of request message 226 to determine whether the artifact 270 of the submission 222 has been previously analyzed and return a response message 228, which includes a verdict of such analysis (benign, malicious, unknown) and/or additional meta-information associated with the prior evaluated artifact and/or analysis. The verdict 229 may be returned to the network device 224. The additional meta-information may be stored in the data store 310 and related to the artifact 270 (e.g., stored as meta-information associated with the artifact 270). Herein, the additional meta-information may include distinctive metadata (e.g., hash value) associated with the prior evaluated artifact, the software profile used during analysis of the prior evaluated artifact, timestamp as to the analysis of the prior evaluated artifact, a source of the prior evaluated artifact, or the like.

Responsive to a malicious verdict, the processor(s) 300 processes the notification logic 350, which generates or initiates the generation of an alert directed to a security administrator associated with a source of the submission 222 that the artifact 270 has been determined as “malicious.” This may prompt the security administrator to quarantine (or temporarily remove) the “user” network device that uploaded the submission to allow the security administrator to disinfect the network device. Also, when implemented, the processor(s) 300 may process the detailed analysis engine 355, which performs additional analyses (e.g., behavioral analyses, static analyses, etc.) on the artifact 270 to re-confirm benign or malicious classification, or in response to receipt of an “unknown” classification, to perform or initiate the performance of such analyses to determine whether the artifact 270 may not be determined as “benign” or “malicious.” It is contemplated, however, that these additional analyses may be performed on a different network device other than the cybersecurity sensor 220₁ as shown in FIG. 3B.

Referring to FIG. 3B, a second exemplary embodiment of the cybersecurity sensor 220₁ collectively operating with an auxiliary network device 370 deployed within or outside of the comprehensive cybersecurity platform (CCP) 100 of FIG. 1 is shown. Herein, the functionality associated with the meta-information extraction logic 335, the timestamp generation logic 340 and the hashing logic 345 are performed by the cybersecurity sensor 220₁ while the functionality associated with the submission analysis logic 330, the notification logic 350, and/or the detailed analysis engine 355 are performed by the auxiliary network device 370. It is contemplated that the functionality described above can reside within the cybersecurity sensor 220₁ or may be organized in accordance with a decentralized scheme with multiple network devices performing such functionality in concert.

Referring now to FIG. 3C, an exemplary embodiment of the network device (endpoint) 224 deployed within the CCP 100 of FIG. 2A is shown. According to this embodiment of the disclosure, the network device 224 comprises a plurality of components, including one or more hardware processors 375 (referred to as “processor(s)”), a non-transitory storage medium 380, a local data store 385, and at least one communication interface 390. As illustrated, the endpoint 130₁ is a physical network device, and as such, these components are at least partially encased in a housing.

As described, the hardware processor(s) 375 is a multi-purpose, processing component that is configured to execute logic 381 maintained within the non-transitory storage medium 380 operating as a memory. The local (e.g., on-premises) data store 385 may include non-volatile memory to maintain metadata associated with prior evaluated events in accordance with a prescribed storage policy (e.g., cache validation policy). The prescribed storage policy features a plurality of rules that are used to determine entry replacement and/or validation, which may impact the categorization of a detected, monitored event as locally “distinct” or not.

The communication interface 390 may be configured as an interface to receive an object 391 (broadly interpreted as an “artifact”) via any communication medium. For instance, the communication interface 390 may be network adapter to receive the object 391 via a network, an input/output (TO) connector to receive the object 391 from a dedicated storage device, or a wireless adapter to receive the artifact via a wireless communication medium (e.g., IEEE 802.11 type standard, Bluetooth™ standard, etc.). The agent 395 may be configured to monitor, perhaps on a continuous basis when deployed as daemon software, for other artifacts (e.g., events or particular types of events) occurring during operation of the network device 224. Upon detecting a monitored event, the agent 395 is configured to determine whether the artifact (e.g., the object and/or the monitored event) is “distinct,” as described herein.

For instance, an artifact may be an object (and/or any resultant events detected during processing of the object 391 using a stored application 384), or during other operations that are not directed to processing of a received object 391 (e.g., logon, attempted network connection, etc.). Especially for the object 391, the agent 395 may rely on the stored application 384, one or more operating system (OS) components 382, and/or one or more software driver(s) 383 to assist in collecting metadata associated with an artifact. When the agent 395 determines the artifact is “distinct” (e.g., distinctive metadata does not currently reside in the local data store 385), the collected metadata may be included as part of a submission 397 provided to the cybersecurity sensor 120₁ of FIG. 1.

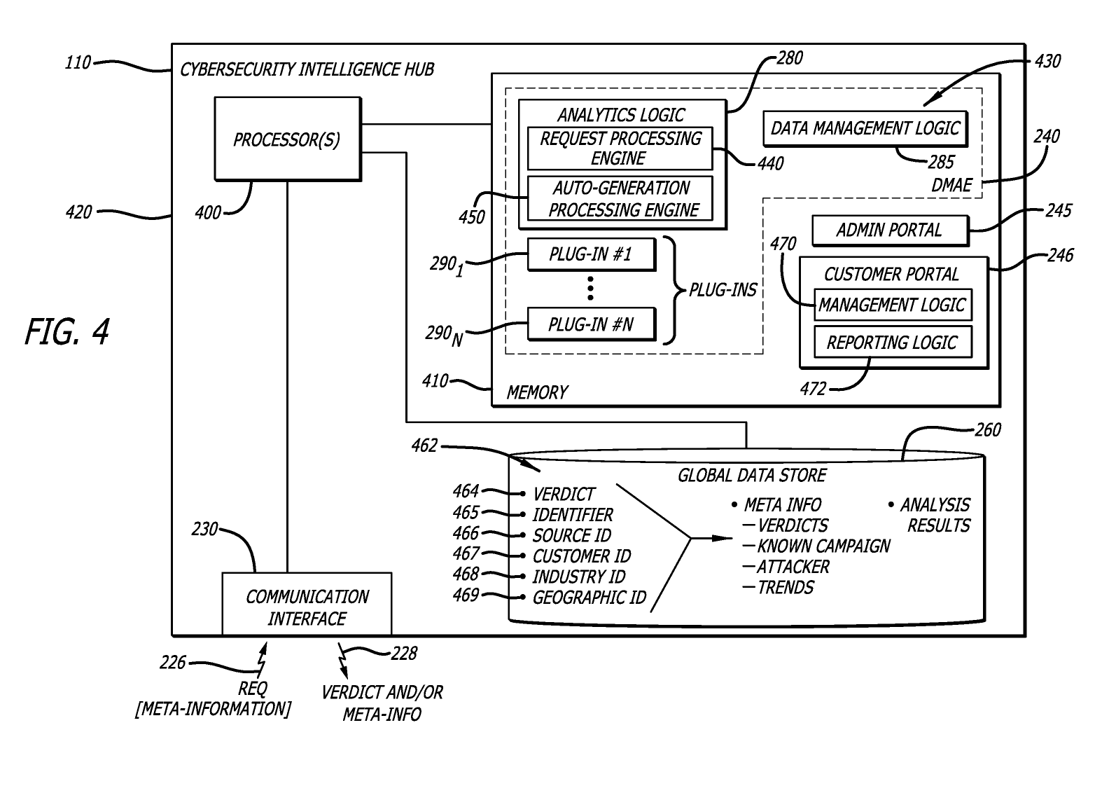

Referring now to FIG. 4, a block diagram of an exemplary embodiment of logic implemented within the cybersecurity intelligence hub 110 of FIG. 2A is shown. According to this embodiment of the disclosure, the cybersecurity intelligence hub 110 comprises a plurality of components, including one or more hardware processors 400 (referred to as “processor(s)”), memory 410, the global data store 260, and the communication interface 230 configured to receive the request message 226, including at least meta-information 272 associated with the artifact 270 as shown in FIG. 2. Herein, when the cybersecurity intelligence hub 110 is a physical network device, these components are at least partially encased in a housing 420 to protect these components from environmental conditions, as described above.

Alternatively, in a virtual device deployment, the cybersecurity intelligence hub 110 may be implemented entirely as software that may be loaded into a network device and operated in cooperation with an operating system (“OS”) running on that device. For this implementation, the architecture of the cybersecurity intelligence hub 110 includes software modules that, when executed by a processor, perform functions directed to functionality of logic 430 illustrated within the memory 410. As described below, the logic 430 may include, but is not limited or restricted to the DMAE 240, which may include (i) the analytics logic 280, (ii) the data management logic 285, and the plurality of plug-ins 290₁-290_{N}. The operations of the analytics logic 280, the data management logic 285, and the plurality of plug-ins 290₁-290_{N} are described herein.

According to one embodiment of the disclosure, the analytics logic 280 features a request processing engine 440 and an auto-generation processing engine 450. The request processing engine 440 is configured to parse request messages for verdict verification and access to meta-information stored at the global data store 260. The auto-generation processing engine 450 is configured, responsive to a triggering event, to active one or more of the plurality of plug-ins 290₁-290_{N} (e.g., plug-ins 290₆-290₉). These plug-ins are configured to verify the accuracy of the verdicts within the stored meta-information (e.g., retroactive re-classification) and/or generate additional cybersecurity intelligence based on the stored meta-information associated with prior evaluation artifacts (e.g., trend spotting, campaign detection, etc.). The analytics logic 280 is further able to provide access by administrators and customers, via the customer portal 246, to stored meta-information within the global data store 260.

The global data store 260 is configured to maintain a plurality of entries (not shown) in which one or more entries are allocated for storing meta-information 462 associated with a prior evaluated artifact. The stored meta-information 462 associated with each prior evaluated artifact may include, but is not limited or restricted to the following parameters: (i) a verdict 464 that identifies a current classification of the prior evaluated artifact; (ii) an identifier 465 (distinctive metadata) that specifically identifies the prior evaluated artifact under analysis (e.g., the artifact to which the stored meta-information 462 pertains); (iii) a source ID 466 (e.g., a specific identifier of the cybersecurity source of the stored meta-information 462); (iv) a customer ID 467 (e.g., a specific identifier of the customer associated with the source ID 466); (v) an industry ID 468 (e.g., a specific identifier of the industry pertaining to the customer); and/or (vi) a geographic ID 469 (e.g., a specific identifier pertaining to a geographic region in which the cybersecurity source resides). Each parameter 464-469 of the stored meta-information 462 could operate as an index used by a consumer via the customer portal 246 of FIG. 2B to search for cybersecurity intelligence. The cybersecurity intelligence may be directed to meta-information or analysis results pertaining to a particular artifact or group (two or more) of artifacts (e.g., artifacts related or temporally proximate to the particular artifact 270 such as a (parent) process that created another (child) process, etc.), a specific customer, industry or geography, or the like.

Besides some or all of the parameters 464-469, it is contemplated that one or more entries (allocated for storing the meta-information 462 associated with a prior evaluated artifact) may include additional meta-information directed to the cybersecurity intelligence 140-170 of FIG. 1 (e.g., uncovered campaign, trend, incident investigation/response intelligence, forensic analysis intelligence, analyst-based intelligence, third-party based intelligence, attacker intelligence, etc.). Also, results of prior analysis of the artifact may be stored within the global data store 260 and accessible.

Additionally, the memory 410 comprises the administrative portal 245 and the customer portal 246. The customer portal 246 further includes a management logic 470 and reporting logic 472. The management logic 470 may be adapted to authenticate a user (e.g., security administrator) requesting access to the cybersecurity intelligence hub 110, where authentication data (e.g., password, URL, customer identifier, etc.) may be obtained from a subscriber database (not shown). After user authentication, the management logic 470 permits a user to (i) gain access to stored content (e.g., meta-information, objects, etc.) with the global data store 260, (ii) configure the reporting logic 472 that, in response to search parameters associated with a query from a customer via the customer portal 246, generates and delivers a report pertaining to some of the stored content (e.g., meta-information), where the report is generated in accordance with a predefined or customized format. The administrative portal 245 has a similar architecture, and further permits the administrator to set configuration data within the cybersecurity intelligence hub 110 (e.g., set time or max count as triggering event for signaling the management subsystem 250 to activate a particular plug-in). This access to the global data store 260 may allow customers to leverage cybersecurity intelligence seen around the platform to generate additional cybersecurity intelligence (e.g., signatures, rules, etc.) based on the stored meta-information.

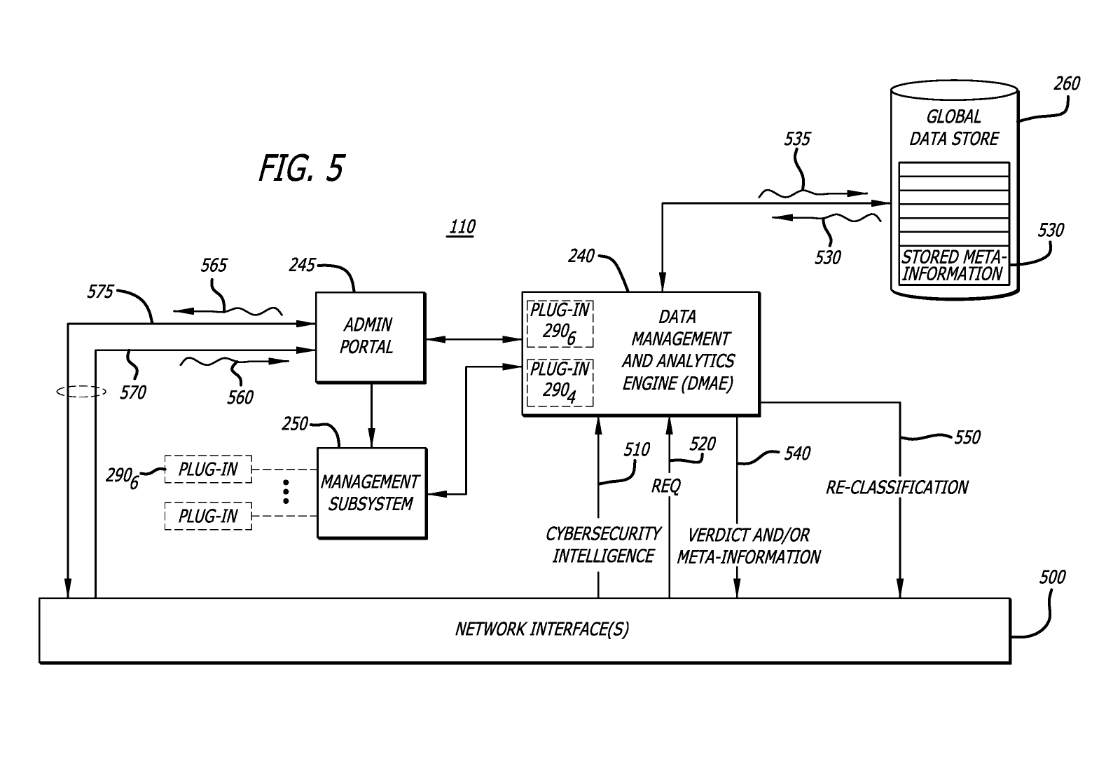

Referring to FIG. 5, a block diagram of logic implemented within the cybersecurity intelligence hub 110 of FIGS. 2A-2C and the signaling exchange via network interface(s) 500 is shown. Herein, the cybersecurity intelligence hub 110 features the DMAE 240 including one or more plug-ins (not shown), a portal 245 (e.g., single portal with operability for administrative/customer access), the management subsystem 250, and the global data store 260. As shown, the DMAE 240 is configured to receive cybersecurity intelligence 510 from cybersecurity sources via the network interface(s) 500 as well as one or more request messages 520 from consumers (including cybersecurity sensors) via the network interface(s) 500.

More specifically, according to one embodiment of the disclosure, a first type of request message 520 may seek a verdict associated with a particular artifact in order to take advantage of prior analyses of the artifact. This scheme increases accuracy in cyber-attack detection while reducing (optimizing) the amount of time necessary to conduct malware analysis on an artifact. Herein, after receipt and processing of the request message 520, the DMAE 240 determines whether a portion of the meta-information associated with the particular artifact (e.g., distinctive metadata) matches a portion of the stored meta-information 530 associated with one or more prior evaluated artifacts maintained by the global data store 260. If so, the consolidated verdict along with at least a portion of the stored meta-information 530 is returned to the sensor via response message 540.

According to one embodiment of the disclosure, the portion of the stored meta-information 530 includes a verdict along with other meta-information such as context information (e.g., source of the prior evaluated artifact, timestamp, incident response information identifying more details of the prior evaluated artifact, successful or unsuccessful remediation attempts, etc.). This context information may assist in the remediation and/or prevention of further cyber-attacks where the artifact is classified as “malicious” and may assist in optimizing processing resources (i.e., avoiding in-depth analysis of the artifact) when the artifact is classified as “benign.”

Alternatively, another type of request message 520 may cause the DMAE 240 to upload analysis results 535 for the particular artifact for storage within an entry or entries of the global data store 260. This request message 520 is to augment the stored meta-information 530 within the global data store 260 from cybersecurity intelligence gathered by a variety of sources.

Besides conducting cybersecurity analyses in response to request messages, as shown in FIG. 5, the management subsystem 250 may invoke (or alternatively cause the DMAE 240 to invoke) one or more plug-ins to generate additional cybersecurity intelligence based on analyses of stored cybersecurity intelligence within the global data store 260. As shown, in response to a triggering event, the management subsystem 250 may invoke the retroactive re-classification plug-in 290₆, which may be registered with the management subsystem 250 (or the DMAE 240 when the plug-in 290₆ is deployed as part of the DMAE 240 as shown in FIG. 2B). The retroactive re-classification plug-in 290₆ is configured to monitor, confirm and perform system-wide correction of prior false positive (FP) and/or false negative (FN) results on a customer or system-wide basis.

In particular, the retroactive re-classification plug-in 290₆ may prompt the data management logic (not shown) within the DMAE 240 to conduct an analysis of the stored meta-information within the global data store 260 to determine whether there exist any verdicts that conflict with trusted (e.g., high level of confidence in its accuracy) cybersecurity intelligence, including an analysis for any inconsistent verdicts for the same artifact. Moreover, the retroactive re-classification plug-in 290₆ may conduct an analysis of the global data store 260 to identify different entries of meta-information associated with the same prior evaluated artifact, but having inconsistent verdicts. After identification, the retroactive re-classification plug-in 290₆ conducts an analysis of the meta-information associated with each of the inconsistent verdicts in efforts to ascertain which of the inconsistent verdicts represents a correct classification for the prior evaluated artifact.

Upon completing the analysis, according to one embodiment of the disclosure, the retroactive re-classification plug-in 290₆ applies a tag to each incorrect verdict. In lieu of being tagged, it is contemplated that the incorrect verdicts may be stored within a portion of the global data store 260 or a separate database (not shown). Independent of the selected mechanism to identify the incorrect verdicts, according to one embodiment of the disclosure, the operations of the retroactive re-classification plug-in 290₆ have completed and notification of any affected customers that received the incorrect verdicts is performed by a reclassification notification plug-in 290₄ (described below). Alternatively, in lieu of a separate plug-in 290₄, the retroactive re-classification plug-in 290₆ may be configured with the notification functionality of the reclassification notification plug-in 290₄.

According to one embodiment of the disclosure, the reclassification notification plug-in 290₄ may be configured to notify the affected customers through a variety of push/pull notification schemes. As an illustrative example, upon completion of the analysis and in according with a push notification scheme, the reclassification notification plug-in 290₄ deployed within the DMAE 240 may notify a contact for the customer (e.g., security administrator), via a report or an alert (notification), that one or more incorrect verdicts previously provided to the customer have been detected. It is contemplated that the notification may be sent to one or more cybersecurity sensors associated with affected customers to the network interface 500 as represented by path 550. Additionally, or in the alternative, the notification may be sent via the portal 245 (e.g., administrative or customer portal). Also, as an alternative or additional transmission path, the notification may be sent to the security administrator via an out-of-band transmission path (e.g., as a text message, email, or phone message).

In lieu of a push delivery, as described above, an authorized administrator, cybersecurity provider or customer may periodically (or aperiodically) issue a request (query) message for updated verdicts via the portal 245 (e.g., administrative portal or customer portal). In response to the query message 560, the DMAE 240 activates the reclassification notification plug-in 290₄, which identifies the incorrect verdicts associated with that customer and assists the DMAE 240 in providing a report 565 identifying these incorrect verdicts via the portal 245. According to one embodiment of the disclosure, it is contemplated that prior (or in response) to the query message 560, the DMAE 240 may collect and provide consolidated meta-information associated with the corrected verdicts to one or more cybersecurity sensors associated with the affected customers via path 550. This consolidated meta-information updates each sensor's data store with the corrected verdicts, and each sensor may provide at least a portion of consolidated meta-information to their supported endpoints. Also, the downloaded, consolidated meta-information assists an administrator (or customer) in updating its system resources (e.g., data store(s) in affected sensors, local data store(s) in affected endpoints, etc.), which allows for verification that the corrected verdicts have been loaded into these resources.

It is contemplated that an authorized administrators and cybersecurity providers may upload meta-information into the global data store 260 via a path 570 including the portal 245, the management subsystem 250 and the DMAE 240. Also, the authorized administrators, cybersecurity providers or customers may conduct searches to retrieve certain stored meta-information from the global data store 260 via path 575 to receive enhanced reports that provide information globally available across the entire platform. As an illustrative example, after credentials are authenticated by the portal 245, an authorized requester may initiate a search with select search parameters to retrieve meta-information such as (i) reclassified verdicts (as described above) or (ii) any grouping of meta-information stored within the global data store 260. The grouping may be directed a certain artifact type (e.g., executable or type of executable, particular type of non-executable, etc.), a certain source (e.g., particular sensor or endpoint), a certain IOC (or identified malware name), certain malicious website, or the like. The search parameters may be further refined based on a selected date/time range.

### V. Plug-in Deployment

Referring now to FIG. 6, a block diagram of an illustrative sets of plug-ins 290₁-290_{N} operating as part of or in conjunction with the DMAE 240 of FIGS. 2A-2C is shown. Installed and registered with logic within the DMAE 240, the plurality of plug-ins 290₁-290_{N} may be separated into sets based on a plurality of selected factors. For illustrative purposes, some of these factors may include (i) whether the plug-in is invoked in response to a request message initiated by a consumer, (ii) general response time needed for the request message (e.g., same communication session, etc.), and (iii) whether the plug-in is activated by a triggering event.

Herein, each plug-in 290₁-290_{N} is configured to perform cybersecurity analyses in which the results are returned to the analytics logic 280 of FIG. 2B-2C. As a result, the plug-in 290₁-290_{N} are used to enhance functionality of the cybersecurity intelligence hub without changes to the overall architecture, and thus, from time to time, a certain subset of the plug-ins 290₁-290_{N} may be installed to adjust operability of the cybersecurity intelligence hub based on the current cybersecurity landscape. For instance, upon detecting a greater number of attacks directed to a particular artifact (e.g., Windows®-based executable), it is contemplated that an additional plug-in may be installed and configured to perform operations directed to that specific type of artifact (object). Hence, the plug-ins 290₁-290_{N} provide flexibility in the types and degrees of analyses conducted for cyber-attack detection and prevention.

For one embodiment of the disclosure, referring back to FIG. 2B, the analytics logic 280 is configured to receive analysis results from a particular plug-in (e.g., plug-in 290₁). Based on the received analysis results and operating in accordance with the analytic rules 282 (e.g., consolidated verdict determination rules 283, analysis ordering rules 281, etc.), the analytics logic 280 generates and provides an output (e.g., consolidated verdict and/or meta-information providing enhanced cybersecurity insights or recommendations) to one or more destinations. These destinations may include a cybersecurity sensor, a network device under control by an administrator (via the administrative portal), a network device under control by a customer (via the customer portal), and/or another (different) plug-in 290₁-290_{N} to perform additional analyses before the analytics logic 280 generates and provides the output. It is also contemplated that the analytics logic 280 may update meta-information within the global data store 260 after such operations. As illustrative plugins, the plurality of plug-ins 290₁-290_{N} may include the first set of plugs 292, the second set of plug-ins 294, and the third set of plugs 296, as described above.

According to another embodiment of the disclosure as shown in FIG. 2C, the analytics logic 280, data management logic 285 and the management subsystem 250 may be operating in accordance with the analytic rules 282. Each of these logic units is configured to receive analysis results from a particular set of plug-in, and thereafter, generate and provide an output to one or more destinations as described above. The provided output may include consolidated verdict and/or meta-information such as a recommendation, contextual information, notifications of past incorrect verdicts, and/or enhanced cybersecurity insights such as metadata identifying a campaign (e.g., multiple malicious artifacts sharing similarities such as similar format or code structure, similar source or destination, etc.) or a trend (e.g., multiple actors using the same approach such as attack procedures, specific type of malicious executable utilized, etc.).

It is also contemplated that the analytics logic 280 (and/or data management logic 285 or management subsystem 250) may store meta-information into the global data store 260 after such operations. As illustrative plugins, the plurality of plug-ins 290₁-290_{N} may include the first set of plugs 292, the second set of 294, and the third set of plugs 296, as described herein.

### A. Illustrative Example—First Set of Plug-Ins

A first plug-in 290₁ may be configured to conduct an analysis of meta-information representing an artifact, which is provided by a requesting cybersecurity sensor or another information consumer, to determine whether the artifact should be classified as “benign”. More specifically, the first plug-in 290₁ receives as input, from the analytics logic, meta-information 600 associated with the artifact included in a request message. The meta-information 600 may include distinctive metadata, which may be used by the first plug-in 290₁ to determine whether there is sufficient evidence, based on comparison of the distinctive metadata to cybersecurity intelligence directed to known benign artifacts stored within the global data store 260, to classify the object as “benign” and provide an analysis result 605 (e.g., one or more verdicts and related meta-information as a result).

As an illustrative example, the meta-information 600 includes a hash value of the artifact (i.e., object). The hash value is compared against known benign hash values (e.g., using whitelist and other cybersecurity intelligence) as well as hash values associated with prior evaluated artifacts. Based on its findings, the first plug-in 290₁ determines whether the artifact (represented by the hash value) is benign and provides the result 605 to the analytics logic (not shown). Thereafter, based on the consolidated verdict determination rules, the analytics logic processes the result to determine a consolidated verdict for return as a response to the request message.

A second plug-in 290₂ may be configured to conduct an analysis of meta-information representing an artifact, which is provided by a requesting cybersecurity sensor or another information consumer, to determine whether the artifact should be classified as “malicious”. Similar to the description above, the second plug-in 290₂ receives as input, from the analytics logic (see FIG. 2A), meta-information 610 associated with the artifact included in a request message. The meta-information 610 may include distinctive metadata, which may be used by the second plug-in 290₂ to determine whether there is sufficient evidence, based on comparison of the distinctive metadata to cybersecurity intelligence directed to known malicious artifacts stored within the global data store 260, to classify the object as “malicious” and provide the analysis result 615.

As an illustrative example, the meta-information 610 includes a hash value of the artifact (i.e., object). The hash value is compared against known malicious hash values (e.g., using blacklist and other cybersecurity intelligence) as well as analysis of verdicts associated with prior evaluated artifacts with a matching hash value. Based on its findings, the second plug-in 290₂ determines whether the artifact (represented by the hash value) is malicious and provides the result 615 to the analytics logic (not shown). Thereafter, as described above, a consolidated verdict for the artifact is determined and a response to the request message is provided with the consolidated verdict (and meta-information associated with the consolidated verdict).

Similar in operation to plug-ins 290₁ and 290₂, a third plug-in 290₃ may be configured to conduct an analysis of meta-information representing an artifact, which is provided by a requesting cybersecurity sensor or another information consumer, to determine whether the artifact should be classified as “unknown,” neither benign nor malicious. As input, the third plug-in 290₃ receives, from the analytics logic, meta-information 620 associated with an artifact. The meta-information 620 may include distinctive metadata (as described above) for use in locating meta-information associated with one or more prior evaluated artifacts correspond to the artifact residing in the global data store and other stored cybersecurity intelligence (e.g., analyst analyses, third party sources, whitelists, blacklists, etc.). Upon determining that there is insufficient evidence to classify the artifact as “malicious” or “benign,” the third plug-in 290₃ provides a result 625 identifying an “unknown” classification for the artifact based on its analysis of the meta-information 620. The analytics logic determines the consolidated verdict, which may be sent with related meta-information including a recommendation.

According to one embodiment of the disclosure, the recommendation may initiate or prompt (suggest) the additional analysis of the artifact based on knowledge of the capabilities of the source issuing the request message that may be stored as a portion of meta-information within the global data store 260. For example, where the meta-information 620 identifies the source of the request message as a cybersecurity sensor equipped to perform only limited artifact analytics (e.g., no behavioral malware analysis capabilities), the recommendation included in the result 625 may be directed to additional static analyses that may be handled by the sensor and/or include information (e.g., link, instruction, etc.) that may cause the cybersecurity sensor to submit the artifact to an analysis system remotely located from the sensor. Alternatively, where the meta-information 620 identifies the source of the request message as a cybersecurity sensor equipped to perform any cybersecurity analysis (e.g., static malware analysis, behavioral malware analysis, and/or inspection through machine learning models), the recommendation may prompt the cybersecurity sensor to perform or initiate one or more of such analyses at the sensor.

Besides the type of additional analysis or analyses, the recommendation may include a selected order of analyses or identify certain characteristics or behaviors of importance in a more detailed analysis of the artifact at the sensor. The characteristics may be directed to particular aspects associated with the structure and content of the artifact (e.g., code structure, patterns or signatures of bytes forming the object, etc.). The behaviors may be identified as certain behaviors that should be monitored at run-time within a virtual machine or may constitute events detected using machine-learning models. The recommendation may further include a selected order of additional plug-in analyses that may assist in determining a known verdict for the artifact (e.g., verdicts indicate benign, but the benign artifacts have certain abnormalities (described below) that may suggest submission of the consolidated meta-information from the third plug-in 290₃ to an eighth (campaign) plug-in 290₈.

As an alternative embodiment, it is contemplated that the first, second and third plug-ins 290₁-290₃ may be configured to determine the consolidated verdict and provide the same to the analytics logic 280. For this embodiment, the analytics logic 280 may either provide the consolidated verdict to the requesting entity (e.g., cybersecurity sensor) or alter the provided consolidated verdict if the analytic rules 282 feature constraints on the analytics logic 280 providing known verdicts and those constraints are not satisfied, as described above.

### B. Illustrative Example—Second Set of Plug-Ins

A fourth plug-in 290₄ may be configured to generate a response 635 to meta-information 630 configured to identify inconsistent verdicts associated with a particular consumer, such as a particular network device (identified by the submitted Device ID) or a particular customer (identified by the submitted Customer ID). These inconsistent verdicts may be detected based on operations performed by the sixth (retroactive reclassification) plug-in 290₆ described below. Upon receipt of a query for updated verdicts from a consumer, the analytics logic invokes the fourth plug-in 290₄ and passes the information associated with the query, including the Customer ID, to the plug-in 290₄. The plug-in 290₄ processes the query and returns prior analyses results for that particular customer that are inconsistent for the same artifact.

Additionally, the fourth plug-in 290₄ may be configured to generate a verdict update message or provide meta-information for the generation of this message by logic within the DMAE (e.g. analytics logic). The verdict update message identifies one or more of the inconsistent verdicts detected by the sixth (retroactive reclassification) plug-in 290₆ and corrected within the global data store. The verdict update message provides meta-information that identifies which verdicts have been incorrectly classified and the correct verdicts (e.g., “malicious” corrected as “benign”; “benign” corrected as “malicious”, etc.). The verdict update message may be utilized by one or more cybersecurity sensors to alter stored meta-information within their data store(s) and/or local data stores within endpoints supported by these cybersecurity sensor(s).

A fifth plug-in 290₅ may be configured to receive cybersecurity information regarding previously encountered incidents exhibiting one or more identified IOCs 640, which may be utilized as a search index. The received cybersecurity information may be used to augment stored cybersecurity intelligence within the global data store, where the augmented cybersecurity intelligence may be subsequently accessed via an administrative portal by the incident responder to receive contextual information 645. The contextual information may enhance understanding of the artifact under analysis that may assist in the current incident investigation and provide context to the results of this investigation, which may be included in a report to the customer who commissioned the investigation or may be used in verifying the results of the investigation.

### C. Illustrative Example—Third Set of Plug-Ins

The sixth plug-in 290₆ (Retroactive Reclassification) may be invoked in response to a triggering event 650, such as a scheduled event (e.g., timeout, max count, etc.) or a dynamic event (e.g., administrator-initiated or plug-in generated event). Once invoked, the sixth plug-in 290₆ is configured to perform a platform-wide, reclassification analysis of meta-information within the global data store 260 of FIG. 2A for any conflicts between the meta-information and trusted cybersecurity intelligence (e.g., verdicts now considered to be incorrect based on new intelligence such as determination of a hijacked website or a malicious web domain, etc.) and/or any abnormalities (e.g., inconsistent verdicts, verdicts that are based on stale meta-information that renders them suspect or incorrect, or in some cases, earlier benign verdict(s) for which a later discovered trend or campaign would indicate that these earlier benign verdict(s) may be suspect and the corresponding artifact(s) should be reclassified as malicious), where such conflicts or abnormalities may identify incorrect verdicts 655 associated with stored meta-information representing a false positive (FP) and/or false negative (FN).

According to one embodiment, the reclassification analysis may be initiated by the triggering event 650, which may include one or more search parameters for this analysis. The search parameters may be time-based (e.g., reclassification analysis directed to entries of the global data store that are newly created or modified within a prescribed period of time), customer-based (e.g., reclassification analysis directed to a specific customer selected in accordance with a round-robin selection scheme or a weighted scheme where the frequency of the analysis is dependent on a subscription level paid by the customer for the services offered by the cybersecurity intelligence hub), industry-based, or the like. Additionally, or in the alternative, the reclassification analysis may be initiated by an administrator via the administrative portal, where the search parameters may be directed to a particular time frame, a particular customer, a particular submission from a cybersecurity sensor, a particular artifact (based on selected distinctive metadata such as hash value, source IP address, etc.), or the like.

As described above, the retroactive re-classification plug-in 290₆ may control operations of the data management logic in accessing meta-information within the global data store to identify conflicts with trusted cybersecurity intelligence. For example, based on newly available cybersecurity intelligence (e.g., identification of a malicious source such as a malicious website), the retroactive re-classification plug-in 290₆ may conduct an analysis of stored meta-information within the global data store to identify any meta-information including a source address (e.g., IP address, domain name, etc.) for a currently identified malicious website separate from analysis of the consistency of the verdicts as described below. Each verdict associated with the detected meta-information sourced by the malicious website is set to a “malicious” classification.

As another example, the retroactive re-classification plug-in 290₆ may conduct an analysis of the global data store 260 to identify any inconsistent verdicts for the same, prior evaluated artifact. After identification, the retroactive re-classification plug-in 290₆ conducts an analysis of the stored meta-information associated with each of the inconsistent verdicts in efforts to ascertain which of the inconsistent verdicts represents a correct classification for the prior evaluated artifact. This analysis may include determining differences that may give rise to different verdicts such as differences in (i) operating environment utilized in assigning a verdict to the prior evaluated artifact that may be included as part of the stored meta-information (e.g., type of guest image, application or OS; amount of compute time expended based on load; date/time of processing; geographic location, etc.), (ii) characteristics of the artifact (e.g., format, enabled features, port configurations, etc.), (iii) the type of analysis conducted to render the verdict, (iv) source of the artifact, or the like.

Upon completing the analysis, according to one embodiment of the disclosure, the retroactive re-classification plug-in 290₆ may apply a tag to each incorrect verdict. In lieu of being tagged, it is contemplated that the incorrect verdicts may be stored within a portion of the global data store or a separate database (not shown). Therefore, the operations of the retroactive re-classification plug-in 290₆ have completed and notification of any affected customers that received the incorrect verdicts may be initiated in response to the reclassification notification plug-in 290₄ (described above). Alternatively, in lieu of a separate plug-in 290₄, the retroactive re-classification plug-in 290₆ may be configured with the notification functionality of the reclassification notification plug-in 290₄.

As described above, the sixth plug-in 290₆ may be configured to identify the inconsistent verdicts and tag the entry or entries associated with the incorrect verdicts. Additionally, the stored meta-information associated with the incorrect verdicts may be analyzed, by logic within the DMAE (see FIGS. 2B-2C) or the sixth plug-in 290₆, to identify whether one of these prior analyses has a higher propensity for accuracy than the other. As a first illustrative example, where meta-information associated with a prior evaluated artifact is initially classified with a “benign” (benign verdict) by a first source, and subsequently, meta-information associated with the prior evaluated artifact is classified with a “malicious” verdict by a second source conducting greater in-depth analysis, the sixth plug-in 290₆ may retroactively re-classify the meta-information from the first source as “malicious” (tagging the meta-information from the first source, modifying or initiating modification of the verdict the verdict associated with the meta-information from the first source). Herein, the retroactive re-classification may occur because the analysis techniques commenced at the first source are not as robust as a static or behavioral malware analysis performed by the second source.

As a second illustrative example, referencing the inconsistent verdicts between the first and second sources described above, both the first and second sources may perform a behavioral malware analysis, but use different software images resulting in different verdicts (for example, where the second source uses a software image with software more vulnerable to an exploit than the software image of the first source). Herein, the sixth plug-in 290₆ may retroactively re-classify the meta-information from the first source as “malicious” as the artifact is malicious even though the software image utilized by the first source, given its ability to more advanced operability, may inherently require a high level of maliciousness to consider the artifact as part of a cyber-attack.

Furthermore, it is contemplated that, given the uncovered conflicts or abnormalities as described above, the sixth plug-in 290₆ may be configured to prompt the data management logic 285 or the analytics logic 280 (see FIGS. 2B-2C) to alter the consolidated verdict for the artifact featuring inconsistent verdicts to be of an “unknown” classification. By altering the classification, the cybersecurity intelligence hub 110 may cause further detailed analyses of the artifact to determine a known, consolidated verdict with a greater level of confidence as to its accuracy.

The seventh and eighth plug-ins 290₇ and 290₈ may be directed to trend identification and campaign detection. For trend identification, in response to a triggering event 660, the seventh plug-in 290₇ is activated and analyzes meta-information within entries of the global data store 260, including meta-information with “benign” and “malicious” verdicts, to identify (from the analyzed meta-information) malicious actors using the same approach in conducting a cyber-attack. These trends may be more verifiable when considering timing of cyber-attacks (e.g., time of day, frequency within a prescribed duration, etc.). The results of the analysis (trend information) 665 is reported to logic within the DMAE.

For example, the seventh plug-in 290₇ may conduct analyses to detect substantially increasing number of “malicious” verdicts associated with stored meta-information within the global data store, where the meta-information is received from different sources and directed to a certain type of artifact (e.g., Windows® OS based executables). The increasing number may be representative of an increase (in percentage) of newly stored meta-information associated with a Windows® OS based executable over a prescribed time range (e.g., last two-weeks of the month) that exceeds a certain threshold. If so, a trend may be detected as to a wide-scale cyber-attack on Windows® OS based executable and further analysis may be conducted to identify the characteristics of the trend (e.g., directed to a certain version of the Windows® OS, time of attack which may signify origin, certain registry keys targeted, etc.). During the trend analysis, it is contemplated that the detection of certain factors (e.g., heavy concentration directed to a certain customer or class of customers, or to a particular network device) may cause the seventh plug-in 290₇ to trigger the campaign detection plug-in 290₈ to further analyze a portion of the meta-information collected during the trend analysis.

Based on the findings, the plug-in 290₇ may provide the analytic results to the analytics logic, which may generate a notification operating as a warning to the one or more customers about the cybersecurity landscape currently determined by the cybersecurity intelligence hub.

For campaign detection, in response to a triggering event, the plug-in 290₈ is activated and analyzes meta-information 670 with entries of the global data store 260 including “malicious” verdicts only. Such analyses are performed to identify targeted and deliberate cyber-attacks based on repetitious attempts to the same network device, the same customer, or the same industry, etc. The result of such analysis (campaign information) 675 may be reported to logic within the DMAE, which generates a notification to associated customers for transmission via the customer portal or an out-of-band transmission path (e.g., as a text message, email, or phone message).

More specifically, the plug-in 290₈ conducts an analysis focused on meta-information with “malicious” verdicts and grouping meta-information sharing similarities. For instance, a campaign analysis may be conducted for meta-information associated with artifacts originated from the same or similar source (e.g., a particular web domain, IP address or geographic location, etc.) or meta-information submissions originating from the same cybersecurity sensor and/or endpoint that denote a concentrated cyber-attack on a particular enterprise and/or device. Based on the findings, the plug-in 290₈ may provide results to be reported to the customer (if a customer-based campaign) or genericized and reported to multiple customers (if an industry-wide campaign).

The ninth plug-in 290₉ is directed to identifying sophisticated cyber-attacks targeting different devices, customers or industries, etc., by collecting meta-information 680 with malicious verdicts for these different devices, customers or industries. From the collected meta-information 680, logic within the plug-in 290₉ operates to detect similarities associated with meta-information within the different devices, customers or industries.

More specifically, the correlation plug-in 290₉ performs a correlation operation across the stored cybersecurity intelligence within the global data store to assimilate related artifacts to develop consolidated meta-information to spot more sophisticated cyber-attacks that may be hidden from spot analysis by a single source. Such sophisticated attacks may include those using, for example, multiple attack stages and/or multiple vectors and/or aimed at multiple targets. The analysis results 685 are reported to logic within the DMAE for subsequent transmission as a report to one or more customers.

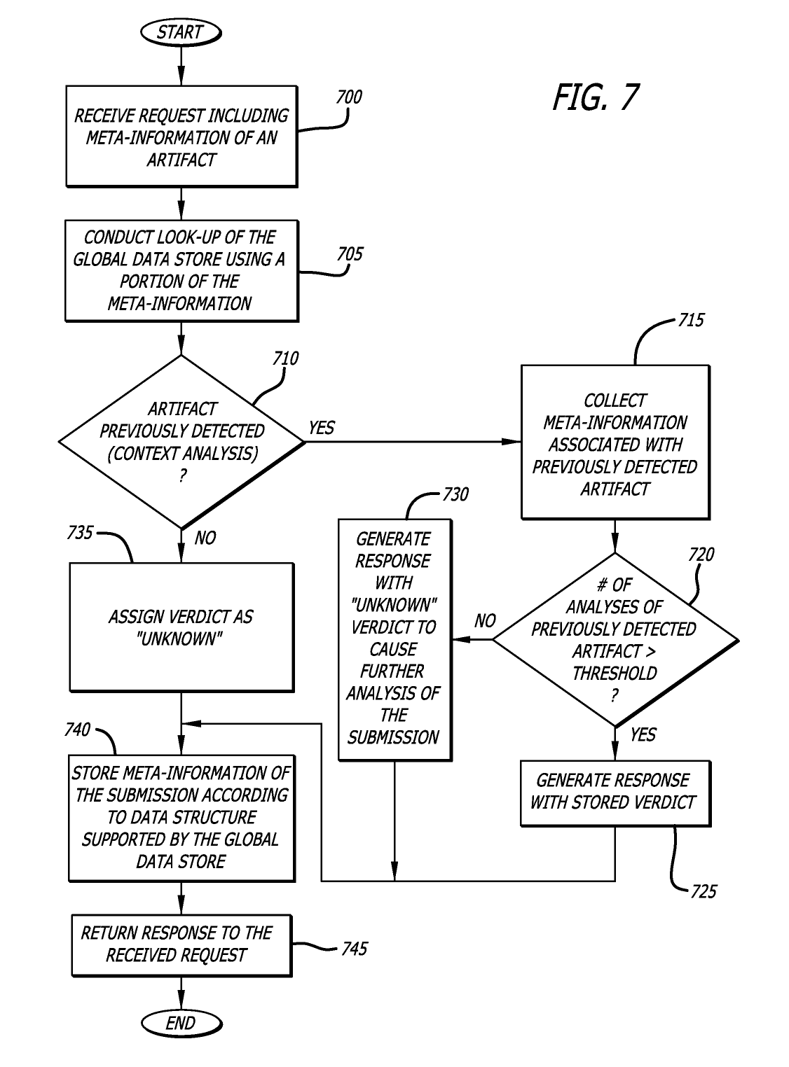

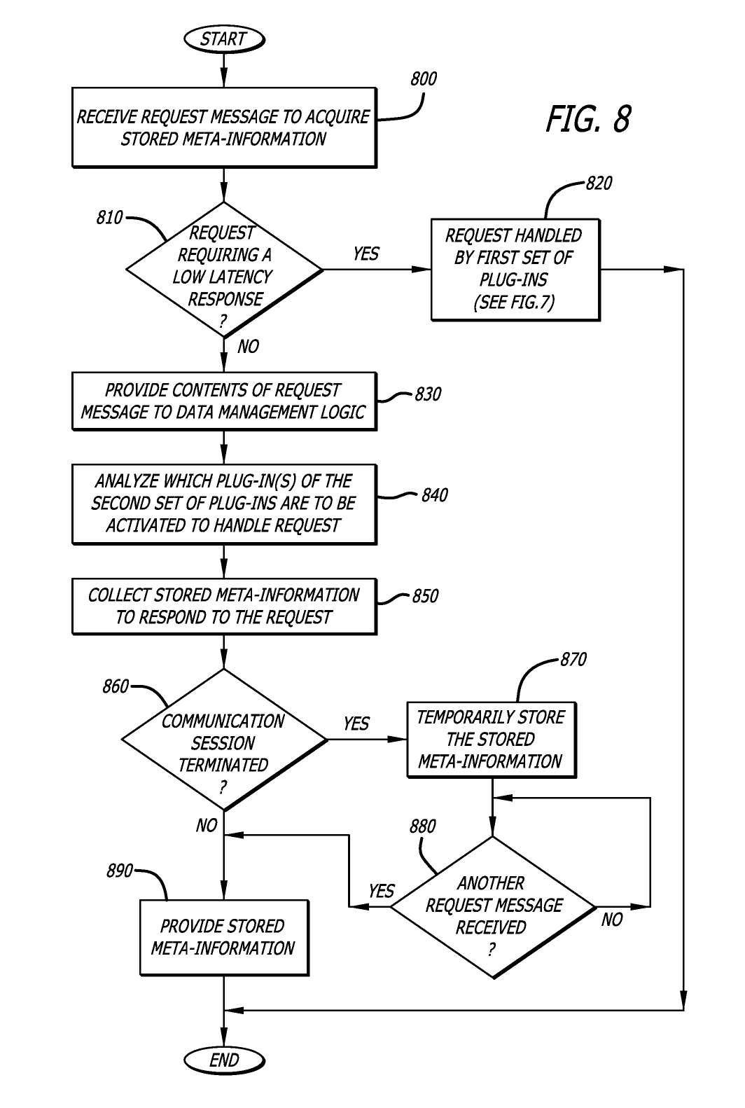

Referring to FIG. 7, an illustrative flow diagram of operations conducted by a plug-in deployed within the cybersecurity intelligence hub 110 of FIG. 2A for responding to a request message for analytics associated with a selected artifact is shown. According to this embodiment of the disclosure, a request message including meta-information associated with an artifact (e.g., executable, non-executable, collection of information associated with a logon or network connection activity) is received (block 700). Using at least a portion of the meta-information associated with the artifact (e.g., distinctive metadata), a review of entries within the global data store is conducted to determine if any prior analyses for the artifact have been stored (block 705).

According to one embodiment of the disclosure, it is contemplated that the global data store may be segmented into and organized as different caches (e.g., different levels; same level, but different cache structures; different cache structures organized to store meta-information associated with analyses of prior evaluated artifacts received within prescribed time ranges, etc.). For instance, a first cache may be configured to maintain meta-information associated with analyses conducted on prior evaluated artifacts during a current calendar day. A second (larger sized) cache may be configured to maintain meta-information uploaded associated with analyses conducted on prior evaluated artifacts during the current week, etc.).

Upon determining that the stored meta-information associated with a prior evaluated artifact matching the artifact (or activity) has been previously stored (block 710), this stored meta-information, including a stored verdict is collected and a response message including the stored consolidated meta-information for the prior evaluated artifact (or activity) is generated (blocks 715 and 725). As an optional operation, prior to generating the response message, a determination is made as to whether the number of stored evaluations of the artifact exceeds a verdict threshold (block 720). If so, the response message including at least the known verdict (e.g., malicious or benign) is generated as set forth in block 725. Otherwise, the response message is generated with an “unknown” verdict to prompt further malware analyses of the artifact and subsequent storage of the malware analysis results into the global data store within one or more entries allocated to the artifact (block 730). Besides the verdict, additional meta-information extracted from the one or more entries associated with the prior evaluated artifact is included in the response message.

If the meta-information associated with a prior evaluated artifact has not been previously stored in the global data store, the verdict associated with the artifact is set to an “unknown” classification. Thereafter, further analyses (or retrieval of the object for analysis) may be conducted in efforts to determine a definitive classification (e.g., malicious or benign) for the artifact (block 735). The meta-information associated with the artifact (or activity) is stored in the global data store (block 740). The response message is returned to the requesting consumer (block 745).

Referring now to FIG. 8, an illustrative flow diagram of operations conducted by a plug-in deployed within the cybersecurity intelligence hub of FIG. 2A for responding to a request message for analytics is shown. Herein, according to one embodiment of the disclosure, a request message directed to acquiring stored meta-information from the global data store is received from a customer (block 800). Analytics logic within the cybersecurity intelligence hub determines whether the request message is directed to low-latency request to be handled by the first set of plug-ins (block 810). If so, the request message is handled during the same communication session as illustrated in FIG. 7 and described above (block 820). Otherwise, the request message is handled at a higher latency (e.g., lower priority) than the low-latency requests and the contents of the request message are provided to the data management logic (block 830).

The data management logic analyzes the incoming content of the request message to determine which plug-in(s) are activated to perform the requisite operations to service the request message (block 840). Also, the plug-in(s) may collect information in responding to the request message after the communication session initiated by the request message has terminated (block 850). If the communication session has terminated, the obtained information may be temporarily stored in the global data store or a type of temporary storage such as a volatile memory (blocks 860 and 870). In response to receiving another request message from the customer, the obtained information is returned to the customer (blocks 880 and 890), although not shown, the obtained information may be provided to the customer in lieu of the “pull” delivery scheme described above.

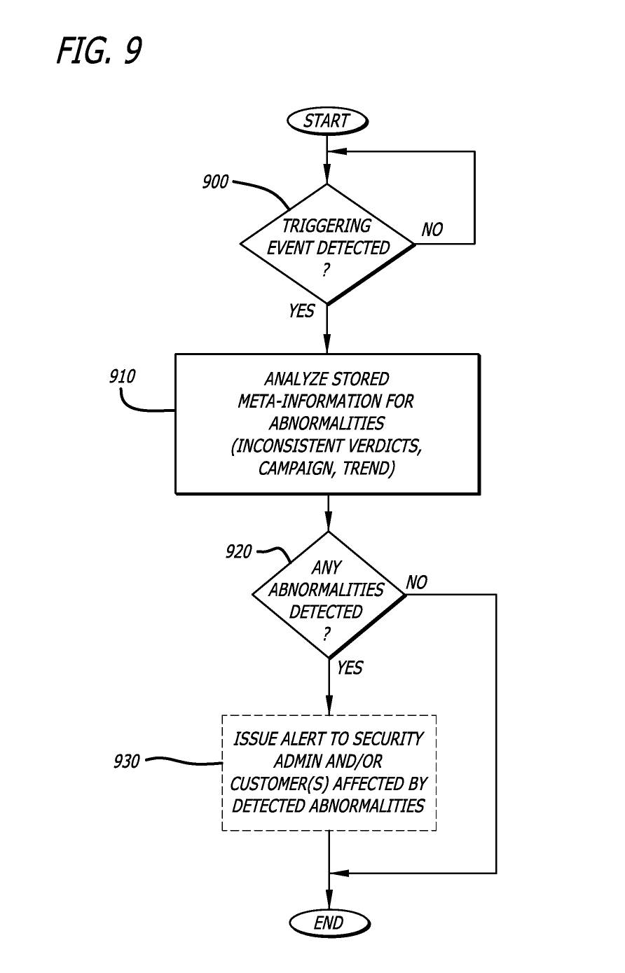

Referring to FIG. 9, an exemplary flow diagram of operations conducted by a plug-in of the cybersecurity intelligence hub of FIG. 2A in response to a configurable, triggering event, a particular plug-in is activated to analyze the stored meta-information within the global data store to determine whether any abnormalities (e.g., inconsistent verdicts, or stale verdicts that are now incorrect based on additional intelligence including determination of potential trends or campaigns, etc.) are determined (blocks 900-910). For example, where the plug-in is a retroactive re-classification plug-in and upon confirmation of a re-classification event as described above, the updated cybersecurity intelligence (e.g., confirmed consolidated verdict) is provided to the sources that previously received incorrect consolidated verdicts (block 920). If any abnormalities are detected, a notification (e.g., an alert) may be issued to security administrator (block 930).

In the foregoing description, the invention is described with reference to specific exemplary embodiments thereof. However, it will be evident that various modifications and changes may be made thereto without departing from the broader spirit and scope of the invention as set forth in the appended claims.

What is claimed is:

1. A system for detecting artifacts associated with a cyber-attack, comprising:
a first network device; and
a second network device remotely located from and communicatively coupled over a network to the first network device, the second network device comprises a data store including stored meta-information associated with each artifact of a plurality of artifacts and each stored meta-information includes a verdict classifying an artifact corresponding to the stored meta-information as a malicious classification or a benign classification, wherein the second network device being configured to (i) receive meta-information associated with a first artifact from the first network device, and (ii) determine a verdict for the first artifact upon (a) analyzing a portion of the meta-information associated with the first artifact and a portion of the stored meta-information associated with each of the plurality of artifacts including a portion of the stored meta-information associated with at least a second artifact of the plurality of artifacts, and (b) providing, from the second network device to the first network device, a verdict of at least the second artifact as the verdict for the first artifact in response to the portion of the meta-information associated with the first artifact being determined by the second network device to match the portion of the stored meta-information associated with the second artifact.

2. The system of claim 1, wherein the second network device to determine the verdict for the first artifact without conducting a malware analysis on the first artifact.

3. The system of claim 2, wherein the first network device issuing an alert message to notify an administrator of a detection of the first artifact being part of a cyber-attack in response to the verdict for the first artifact being malicious classification.

4. The system of claim 1, wherein the second network device being a cybersecurity sensor communicatively coupled to a plurality of endpoints including the first network device, the cybersecurity sensor to determine classifications for artifacts represented by submitted meta-information from the plurality of endpoints.

5. The system of claim 1, wherein the second network device analyzing the portion of the meta-information associated with the first artifact and the portion of the stored meta-information associated with the second artifact by at least comparing whether the portion of the meta-information associated with the first artifact matches the portion of the meta-information associated with the second artifact.

6. The system of claim 5, wherein the portion of the meta-information associated with the first artifact includes distinctive metadata distinguishing the first artifact from each of the plurality of artifacts except for any artifact of the plurality of artifacts being represented by stored meta-information on which a portion of the stored meta-information matches the distinctive metadata.

7. The system of claim 6, wherein the first artifact is an object and the distinctive metadata includes a hash value of the object.

8. The system of claim 7, wherein the portion of the stored meta-information associated with the second artifact matching the hash value of the object.

9. The system of claim 1, wherein the second network device being further configured to (i) store the received meta-information associated with the first artifact within the data store in response to the portion of the meta-information associated with the first artifact failing to match the stored meta-information associated with each of the plurality of artifacts, and (ii) provide the received meta-information associated with the first artifact to a third network device including a global data store, wherein the third network device to provide the verdict for the first artifact to the second network device in response to the portion of the meta-information associated with the first artifact being determined by the third network device to match a portion of stored meta-information associated a third artifact stored within the global data store.

10. The system of claim 1, wherein the second network device being a cybersecurity intelligence hub remotely located from and communicatively coupled over a network to a plurality of network devices including the first network device, the cybersecurity intelligence hub being configured to (i) consolidate cybersecurity intelligence including the stored meta-information being associated with each of the plurality of artifacts and received from a plurality of cybersecurity sensors including the first network device operating as a cybersecurity sensor, (ii) determine whether the consolidated cybersecurity intelligence includes cybersecurity intelligence corresponding to the first artifact using the portion of the meta-information associated with the first artifact, and (iii) provide a consolidated verdict being part of the cybersecurity intelligence identifying whether the first artifact is of a known or unknown classification including at least a malicious classification or a benign classification.

11. The system of claim 10, wherein the consolidated verdict being a selected verdict based on a plurality of verdicts extracted from stored meta-information associated with two or more of the plurality of agents matching the portion of the meta-information associated with the first artifact.

12. A cybersecurity intelligence hub configured for network connectivity to a plurality of cybersecurity sensors to detect whether an artifact is associated with a cyber-attack without execution of the artifact, comprising:
a communication interface;
a hardware processor communicatively coupled to the communication interface;
a global data store communicatively coupled to the hardware processor;
a memory communicatively coupled to the hardware processor, the memory including a data management and analytics engine to
(i) consolidate cybersecurity intelligence for prior evaluated artifacts, wherein the consolidated cybersecurity intelligence being received from the plurality of cybersecurity sensors for storage in the global data store, a first portion of the consolidated cybersecurity intelligence being associated with a first plurality of the prior evaluated artifacts previously analyzed for malware, and cybersecurity intelligence for each corresponding artifact of the first plurality of prior evaluated artifacts being assigned a consolidated verdict identifying whether the corresponding artifact is determined to be at least of a malicious classification or a benign classification, and
(ii) generate additional cybersecurity intelligence based on the consolidated intelligence to provide contextual information to a cybersecurity sensor of the one or more cybersecurity sensors enhance assessment of a potential cyber-attack.

13. The cybersecurity intelligence hub of claim 12, wherein the data management and analytics engine being further configured to:
(iii) receive a message requesting a consolidated verdict for the artifact from a cybersecurity sensor of the one or more cybersecurity sensors;
(iv) determine whether the consolidated cybersecurity intelligence includes cybersecurity intelligence directed to the artifact; and
(v) provide, to the cybersecurity sensor, meta-information being part of the cybersecurity intelligence directed to the artifact in response to the cybersecurity intelligence hub determining that the consolidated cybersecurity intelligence includes the cybersecurity intelligence directed to the artifact, the meta-information including a consolidated verdict for the artifact identifying whether the artifact as having a known or unknown classification including a malicious classification or a benign classification.

14. The cybersecurity intelligence hub of claim 13, wherein the data management and analytics engine further determines whether the consolidated cybersecurity intelligence includes the cybersecurity intelligence directed to the artifact by at least (a) parsing the message to extract distinctive metadata from meta-information associated with the artifact within the request message, the distinctive metadata distinguishes the artifact from other artifact and (b) conducting a comparison between the distinctive metadata and meta-information with the consolidated cybersecurity intelligence associated with each of the prior evaluated artifacts to determine whether at least one of the prior evaluated artifacts corresponds to the artifact and the cybersecurity intelligence directed to the artifact resides within the consolidated cybersecurity intelligence.

15. The cybersecurity intelligence hub of claim 12, wherein the memory further comprises a portal being used, prior to the management and analytics engine determining whether the consolidated cybersecurity intelligence includes the cybersecurity intelligence directed to the artifact, to authenticate a source of the request message.

16. The cybersecurity intelligence hub of claim 12, wherein the data management and analytics engine being further configured to:
(iii) receive a query message via a customer portal for cybersecurity intelligence directed to a particular customer;
(iv) determine whether the consolidated cybersecurity intelligence includes the cybersecurity intelligence; and
(v) return, via the customer portal, meta-information being part of the cybersecurity intelligence directed to the particular customer in response to the cybersecurity intelligence hub determining that the consolidated cybersecurity intelligence includes the cybersecurity intelligence.

17. The cybersecurity intelligence hub of claim 16, wherein the consolidated cybersecurity intelligence being provided by at least a first cybersecurity source and a second cybersecurity source being different than the first cybersecurity source.

18. The cybersecurity intelligence hub of claim 17, wherein the first cybersecurity source providing incident investigation/response intelligence including cybersecurity intelligence gathered by cyber-attack incident investigators during analyses of successful attacks and the second cybersecurity source providing cybersecurity intelligence produced by network devices using malware detection analysis models formulated by machine-learning driven forensic engines in classifying artifacts as malicious or benign.

19. The cybersecurity intelligence hub of claim 12 further comprising a portal to provide an interface to conduct a search of the consolidated cybersecurity intelligence for the prior evaluated artifacts stored in the global data store.

20. The cybersecurity intelligence hub of claim 12, wherein the portal provides the interface to conduct a search based on one or more selected parameters for use as a search index for stored meta-information being part of the consolidated cybersecurity intelligence within the global data store.

21. A system comprising:
a plurality of network devices operating as a plurality of cybersecurity sensors; and
a cybersecurity intelligence hub remotely located from and communicatively coupled to the plurality of cybersecurity sensors over a network, the cybersecurity intelligence hub including
a global data store, and
a processor communicatively coupled to the global data store, the processor to (i) store meta-information for each of a plurality of prior evaluated artifacts within the global data store, (ii) receive meta-information associated with an artifact from a cybersecurity sensor of the plurality of cybersecurity sensors, (iii) determine whether a portion of the received meta-information associated with the artifact matches a portion of the stored meta-information associated with any of the plurality of prior evaluated artifacts within the global data store, and (iv) provide a consolidated verdict identifying a classification for the artifact, including whether the artifact is of a malicious classification or a benign classification, in response to determining that a portion of the stored meta-information associated with at least a first prior evaluated artifact of the plurality of prior evaluated artifacts matches the portion of the received meta-information associated with the artifact and the consolidated verdict is extracted from the stored meta-information associated with at least a first prior evaluated artifact.

22. The system of claim 21, wherein the stored meta-information is an aggregate of meta-information from the plurality of cybersecurity sensors.
